(19) United States
(12) Patent Application Publication
(10) Pub. No.: US 2026/0194763 A1
(43) Pub. Date: Jul. 9, 2026

(54) OPTICAL DEVICE AND ELECTRONIC DEVICE

(71) Applicant: SEMICONDUCTOR ENERGY LABORATORY CO., LTD., Atsugi-shi, Kanagawa-ken (JP)

(72) Inventors: Ryo HATSUMI, Hadano, Kanagawa (JP); Hisao IKEDA, Zama, Kanagawa (JP); Daiki NAKAMURA, Atsugi, Kanagawa (JP); Tomotaka NISHIMURA, Kawasaki, Kanagawa (JP)

(21) Appl. No.: 19/132,066

(22) PCT Filed: Nov. 23, 2023
(86) PCT No.: PCT/IB2023/061818

§ 371 Date: May 22, 2025

(30) Foreign Application Priority Data
Nov. 30, 2022 (JP) 2022-190932

(51) Int. Cl. G02B 27/28; G02B 27/01; G02B 27/14

(52) U.S. Cl. CPC G02B 27/286; G02B 27/0172; G02B 27/144; G02B 2027/0118

(57) ABSTRACT

An optical device and an electronic device with less stray light are provided. The optical device can be used for a VR device or the like; a concave half-mirror is interposed between a first component and a second component; and the first component and the second component can be formed using the same material or materials whose refractive indices are close to each other. In the optical paths in front and back of the half mirror, a difference between refractive indices can be eliminated or reduced; therefore, light passing through the half mirror can travel almost straight. Accordingly, generation of stray light due to refraction can be inhibited.

### TECHNICAL FIELD

One embodiment of the present invention relates to an optical device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Accordingly, more specific examples of the technical field of one embodiment of the present invention disclosed in this specification include a semiconductor device, a display device, a liquid crystal display device, a light-emitting apparatus, a lighting device, a power storage device, a memory device, an imaging device, an operation method thereof, and a manufacturing method thereof.

Note that in this specification and the like, a semiconductor device generally means a device that can function by utilizing semiconductor characteristics. A transistor and a semiconductor circuit are embodiments of semiconductor devices. In addition, in some cases, a memory device, a display device, an imaging device, or an electronic device includes a semiconductor device.

### BACKGROUND ART

Goggles-type devices and glasses-type devices have been developed as electronic devices for virtual reality (VR), augmented reality (AR), and the like.

In addition, typical examples of display devices that can be used for display panels include a display device including a liquid crystal element and a display device including an organic EL (Electro Luminescence) element, a light-emitting diode (LED), or the like.

Since a display device including an organic EL element does not need a backlight that is necessary for a liquid crystal display device, a thin, lightweight, high-contrast, and low-power display device can be achieved. Patent Document 1, for example, discloses an example of a display device using an organic EL element.

### REFERENCE

### Patent Document

[Patent Document 1] Japanese Published Patent Application No. 2018-107444

### SUMMARY OF THE INVENTION

### Problems to be Solved by the Invention

An electronic device used for VR, AR, or the like is a kind of wearable device and is desirably made small in order to have improved portability and wearability. Thus, an optical device that is designed to have a short focal length is used for such an electronic device.

The optical device has a structure in which an optical path length is ensured by utilizing polarization and reflection between components; meanwhile, unintended surface reflection light, light whose polarization state is lost, or the like attributed to an optical component is generated in some cases. Such light deviates from a normal optical path, enters a user's eye, and is perceived as stray light. Stray light is one factor in deteriorating the quality of an image to be seen.

Thus, an object of one embodiment of the present invention is to provide an electronic device with less stray light. Another object is to provide an electronic device with which a user can see an image with high quality. Another object is to provide a small and thin electronic device. Another object is to provide a novel electronic device.

Note that the description of these objects does not preclude the existence of other objects. One embodiment of the present invention does not necessarily achieve all these objects. Note that other objects will be apparent from the description of the specification, the drawings, the claims, and the like, and other objects can be derived from the description of the specification, the drawings, the claims, and the like.

### Means for Solving the Problems

One embodiment of the present invention relates to an optical device and an electronic device each with less stray light.

One embodiment of the present invention is an optical device including a first circularly polarizing plate, a half mirror, and a second circularly polarizing plate, in which the half mirror is provided between the first circularly polarizing plate and the second circularly polarizing plate, the half mirror has a curved surface that is concave on a side of the second circularly polarizing plate, the half mirror is interposed between a first component and a second component, and a difference between a refractive index of the first component and a refractive index of the second component is less than or equal to 0.3.

One or both of the first component and the second component can have a function of a lens.

An optical adhesive can be provided between the first component and the half mirror or between the second component and the half mirror. In that case, a difference between the maximum value and the minimum value of the refractive indices of the first component, the second component, and the optical adhesive is preferably less than or equal to 0.3.

It is preferable that the first circularly polarizing plate be bonded to the first component with an optical adhesive and the second circularly polarizing plate be bonded to the second component with an optical adhesive.

It is preferable that each of an adhesive surface between the first circularly polarizing plate and the first component and an adhesive surface between the second circularly polarizing plate and the second component be flat.

The first circularly polarizing plate can include a linear polarizing plate and a first retardation plate, and the second circularly polarizing plate can include a second retardation plate and a reflective polarizing plate.

The first circularly polarizing plate can have a function of generating first circularly polarized light, and the second circularly polarizing plate can have a function of reflecting the first circularly polarized light and a function of transmitting second circularly polarized light whose rotating direction is opposite to that of the first circularly polarized light.

The optical device can be provided with a convex lens.

Another embodiment of the present invention is an electronic device including the above-described optical device and a display panel; the first circularly polarizing plate is provided between the display panel and the half mirror; and the second circularly polarizing plate is provided between the half mirror and the convex lens.

Another embodiment of the present invention is an electronic device including the above-described optical device and a display panel; and the convex lens is provided between the display panel and the first circularly polarizing plate.

The display panel preferably includes an organic EL element.

### Effect of the Invention

With one embodiment of the present invention, an electronic device with less stray light can be provided. Alternatively, an electronic device with which a user can see an image with high quality can be provided. Alternatively, a thin and lightweight electronic device can be provided. Alternatively, a novel electronic device can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram illustrating an optical device.

FIG. 2 is a diagram illustrating an optical device.

FIG. 3 is a diagram illustrating an optical device.

FIG. 4A and FIG. 4B are diagrams each showing incident angle dependence of transmittance and reflectance of light entering two media with different refractive indices.

FIG. 5A and FIG. 5B are diagrams each showing incident angle dependence of transmittance and reflectance of light entering two media with different refractive indices.

FIG. 6A to FIG. 6I are diagrams illustrating modes of components included in an optical unit.

FIG. 7 is a diagram illustrating an optical device.

FIG. 8 is a diagram illustrating an optical device.

FIG. 9A to FIG. 9C are diagrams each illustrating a display device.

FIG. 10A and FIG. 10B are diagrams each illustrating a glasses-type device.

FIG. 11A to FIG. 11C are diagrams each illustrating a structure example of a display panel.

FIG. 12A and FIG. 12B are diagrams each illustrating a structure example of a display panel.

FIG. 13A to FIG. 13F are diagrams each illustrating a structure example of a pixel.

FIG. 14A and FIG. 14B are diagrams illustrating a structure example of a display panel.

FIG. 15 is a diagram illustrating a structure example of a display panel.

FIG. 16 is a diagram illustrating a structure example of a display panel.

FIG. 17 is a diagram illustrating a structure example of a display panel.

FIG. 18 is a diagram illustrating a structure example of a display panel.

FIG. 19 is a diagram illustrating a structure example of a display panel.

FIG. 20 is a diagram illustrating a structure example of a display panel.

FIG. 21A and FIG. 21B are diagrams illustrating a vertical transistor.

FIG. 22A is a photograph of a prototyped optical device. FIG. 22B is an enlarged photograph of a display panel. FIG. 22C is a photograph of a glasses-type VR device.

FIG. 23A and FIG. 23B are diagrams each showing emission spectra of a display panel.

FIG. 24A to FIG. 24C are photographs for comparing display of a prototyped optical device and display of products.

### MODE FOR CARRYING OUT THE INVENTION

Embodiments will be described in detail with reference to the drawings. Note that the present invention is not limited to the following description, and it will be readily understood by those skilled in the art that modes and details of the present invention can be modified in various ways without departing from the spirit and scope of the present invention. Therefore, the present invention should not be construed as being limited to the description of embodiments below. Note that in structures of the invention described below, the same reference numerals are used in common, in different drawings, for the same portions or portions having similar functions, and a repeated description thereof is omitted in some cases. Note that the hatching of the same component that constitutes a drawing is sometimes omitted or changed as appropriate in different drawings.

In addition, even in the case where a single component is illustrated in a circuit diagram, the component may be composed of a plurality of parts as long as there is no functional inconvenience. For example, in some cases, a plurality of transistors that operate as a switch are connected in series or in parallel. Furthermore, in some cases, capacitors are separately arranged in a plurality of positions.

In addition, one conductor has a plurality of functions of a wiring, an electrode, a terminal, and the like in some cases. In this specification, a plurality of names are sometimes used for one component. Even in the case where components are illustrated in a circuit diagram as if they were directly connected to each other, the components may actually be connected to each other through one or more conductors; in this specification, even such a structure is included in the category of direct connection.

### Embodiment 1

In this embodiment, optical devices and electronic devices according to one embodiment of the present invention will be described.

One embodiment of the present invention is an optical device. Another embodiment of the present invention is an electronic device such as a goggles-type device or a glasses-type device including the optical device and a display panel. The optical device includes a concave half mirror interposed between a first component and a second component, and the first component and the second component can be formed using the same material or materials whose refractive indices are close to each other.

When there is a difference between refractive indices on the optical paths in front and back of the half mirror, transmitted light other than normal incident light is refracted. In the case where light passing through the half mirror is polarized light, the polarization state is lost due to refraction in some cases, so that stray light is likely to be generated.

Note that stray light refers to light that deviates from the normal optical path. Stray light overlaps with light producing a normal image in the electronic device, and thus is one factor that deteriorates the quality of display to be seen. Note that stray light appears in an unintended position and thus is also referred to as a ghost.

In one embodiment of the present invention, a refractive index difference on the optical path in front and back of the half mirror can be eliminated or reduced, thus light passing through the half mirror can travel almost straight. Alternatively, refraction of light passing through the half mirror can be reduced. Accordingly, generation of stray light due to refraction can be inhibited.

Note that the optical device of one embodiment of the present invention has a structure in which a plurality of optical components are combined. A mechanism in which such a structure is included in a housing of an electronic device is simply referred to as a lens. Alternatively, the mechanism is also referred to as a pancake lens in some cases because of its thin shape.

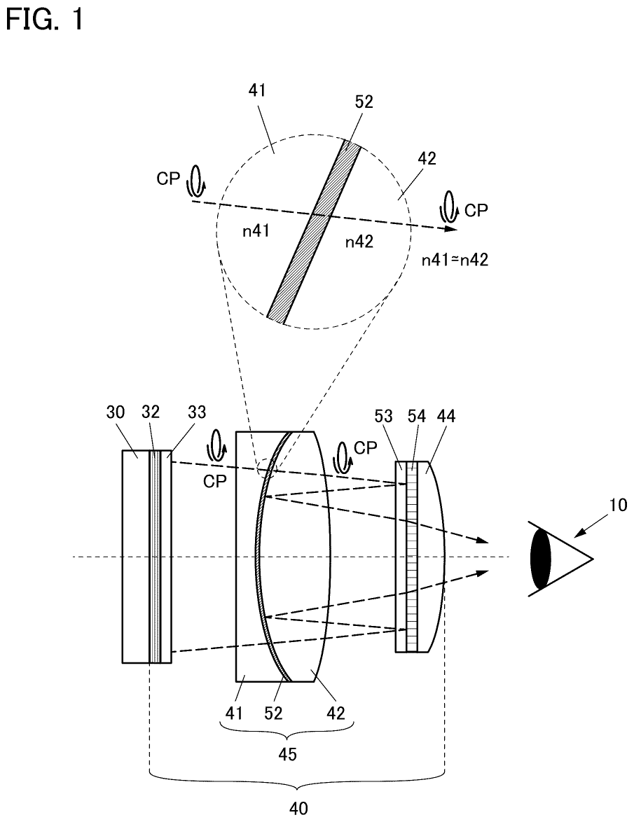

FIG. 1 is a diagram illustrating a cross section including an optical axis in the optical device of one embodiment of the present invention, and part of the optical path is indicated by a dashed line. An enlarged view of some components is also illustrated. Note that a structure in which an optical device 40 and a display panel 30 illustrated in FIG. 1 are combined can be referred to as an electronic device or part thereof.

A user can see an image displayed on the display panel 30 by bringing an eye 10 closer to the optical device 40. The user sees the image while a viewing angle is widened by the optical device 40, and thus can obtain a sense of immersion and a realistic sensation.

The display panel 30 is placed so as to include a region overlapping with a linear polarizing plate 32 and a retardation plate 33 included in the optical device 40. Note that the combination of the linear polarizing plate 32 and the retardation plate 33 is also referred to as a circular polarizing plate that converts non-polarized light to circularly polarized light.

For example, a first surface of the linear polarizing plate 32 can be close to a display portion of the display panel 30 and a second surface of the linear polarizing plate 32 can be close to a first surface of the retardation plate 33. Note that a first surface refers to one surface of each component, and a second surface refers to a surface opposite to the first surface.

The linear polarizing plate 32 and the retardation plate 33 may be provided between the display panel 30 and the optical device 40. Alternatively, a second surface of the retardation plate 33 may be close to an incident surface (a first surface) of an optical unit 45 described below.

The optical device 40 has a structure in which the linear polarizing plate 32, the retardation plate 33, the optical unit 45, a retardation plate 53, a reflective polarizing plate 54, and a lens 44 are arranged in this order to overlap with each other. Optical axes of the optical unit 45 and the lens 44 are placed to intersect perpendicularly with a display portion of the display panel 30.

Note that the term “perpendicular” indicates that the angle formed between two straight lines is greater than or equal to 85° and less than or equal to 95°. Here, one of the two straight lines refers to the optical axis of the optical unit 45 and the lens 44 and the other refers to a straight line parallel to the display portion (display surface).

The combination of the retardation plate 53 and the reflective polarizing plate 54 is also referred to as a circularly polarizing plate that converts non-polarized light to circularly polarized light. Alternatively, the combination can be referred to as a reflective circularly polarizing plate. For example, a first surface of the reflective polarizing plate 54 can be close to a first surface of the retardation plate 53, and a first surface of the lens 44 can be close to a second surface of the reflective polarizing plate 54.

In the case where the above structure in which one component and another component are close to each other is employed, the components are preferably bonded to each other with the use of an optical adhesive which has high transmittance of the wavelength of light used (e.g., the wavelength range of visible light or the wavelength range from blue light to red light) and which does not cause birefringence and absorption of particular polarized light. Alternatively, the another component may be formed on and in contact with the one component not by attachment but by a coating method or the like. Alternatively, without using an adhesive or the like between the one component and the another component, the components may be placed in contact with each other. Alternatively, a space may be provided between the components.

The optical unit 45 has a structure in which a layer 52 having a half mirror function is interposed between an component 41 and an component 42. The layer 52 has a curved surface that is concave on the retardation plate 53 side. The component 41 and the component 42 can be formed using a material having high transmittance with respect to visible light, such as glass or a resin. The layer 52 can be formed using one or both of metal and a dielectric.

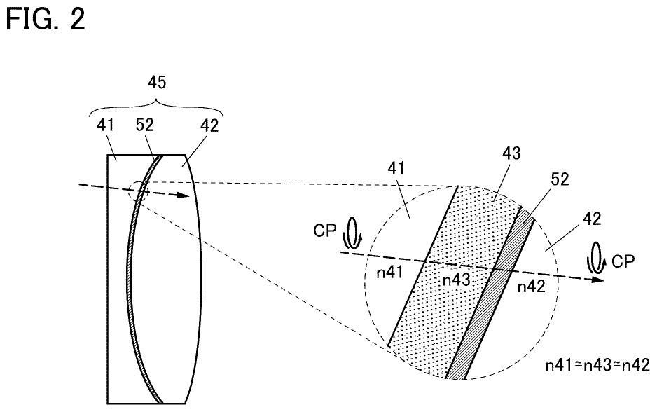

Alternatively, as illustrated in FIG. 2, a structure in which the component 42 and the layer 52 are in contact with each other and an optical adhesive 43 is provided between the component 41 and the layer 52 may be employed. Note that a structure in which the component 41 and the layer 52 are in contact with each other and the optical adhesive 43 is provided between the component 42 and the layer 52 may be employed. A material having a refractive index equivalent to or close to refractive indices of the component 41 and the component 42 is preferably used for the optical adhesive 43. Alternatively, a material having a refractive index between the refractive index of the component 41 and the refractive index of the component 42 is preferably used.

With such a structure, a difference between refractive indices can be eliminated or reduced in the optical paths in front and back of the layer 52, so that light passing through the layer 52 can travel almost straight. Alternatively, refraction of light passing through the layer 52 can be reduced.

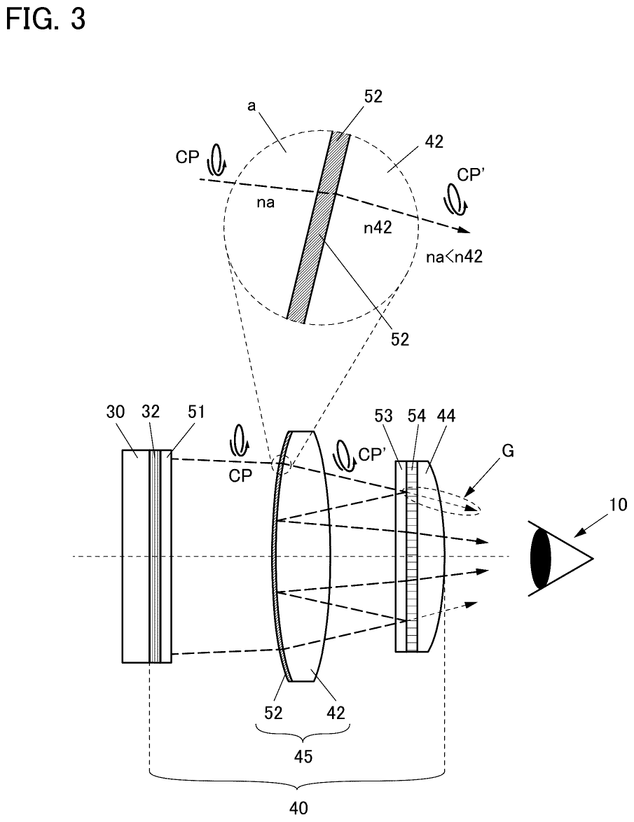

Meanwhile, FIG. 3 illustrates an example in which there is a relatively large difference between refractive indices in the optical path in front and back of the layer 52. In the structure illustrated in FIG. 3, the optical unit 45 is not provided with the component 41 illustrated in FIG. 1, one surface of the convex lens and one surface of the layer 52 are close to each other, and the other surface of the layer 52 is in contact with air a.

In such a state, light is incident on the component 42 from the air a through the layer 52. A refractive index of the air a is nₐ (=1) and a refractive index n₄₂ of the component 42, which is assumed as glass or a resin, is approximately 1.4 to 2.0; therefore, nₐ<n₄₂ is satisfied and light is refracted in accordance with the incident angle.

Here, when incident light is polarized light CP, the polarization state is lost due to refraction and the polarized light CP changes to polarized light CP′ in some cases. In this case, the reflection condition of the polarized light at the reflective polarizing plate 54 cannot be satisfied, and thus part of light passes through the reflective polarizing plate 54. The transmitted light is stray light G, which reduces the quality of display to be seen.

The polarization state is lost because transmittances and reflectances of s-polarized light and p-polarized light vary depending on the incident angle.

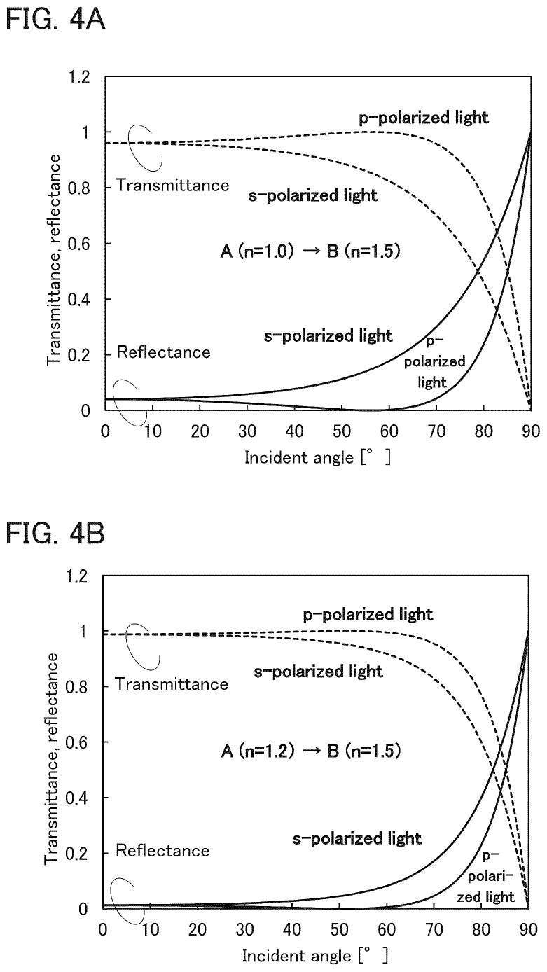

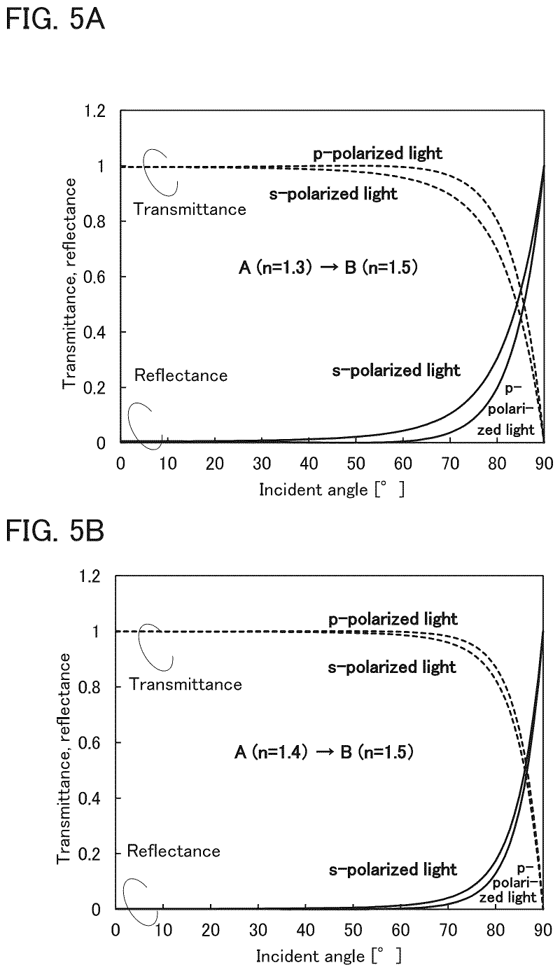

FIG. 4A, FIG. 4B, FIG. 5A, and FIG. 5B are graphs showing calculation results of the incident angle dependence of transmittance and reflectance when the s-polarized light and the p-polarized light are incident between two media (A and B) with different refractive indices.

On the assumption of air and glass or a resin transmitting visible light, transmittance and reflectance of light incident from a medium with a refractive index n of 1 on a medium with a refractive index n of 1.5 are calculated, and the results are shown in FIG. 4A. As shown in FIG. 4A, when the incident angle is relatively large, the difference in each of transmittance and reflectance between the s-polarized light and the p-polarized light is large. That is, the polarization state is easily lost due to refraction.

FIG. 4B shows calculation results of transmittance and reflectance of when light incident from a medium with a refractive index n of 1.2 on a medium with a refractive index n of 1.5. FIG. 5A shows calculation results of transmittance and reflectance when light is incident on a medium with a refractive index n of 1.5 from a medium with a refractive index n of 1.3. FIG. 5B shows calculation results of transmittance and reflectance when light is incident on a medium with a refractive index n of 1.5 from a medium with a refractive index n of 1.4.

It is found that the differences in transmittance and reflectance between the s-polarized light and the p-polarized light are reduced when a difference in refractive index between two media is reduced as described above. That is, reduction in the difference in refractive index between the two media can inhibit loss of the polarization state.

In one embodiment of the present invention, since the refractive index n₄₁ of the component 41, the refractive index n₄₂ of the component 42, and the refractive index n₄₃ of the optical adhesive 43 are substantially equal to or close to each other (n₄₁≈n₄₂ (≈n₄₃)), light passing through the layer 52 can travel almost straight as illustrated in FIG. 1. Alternatively, refraction of light passing through the layer 52 can be reduced. Thus, a change from the polarized light CP to the polarized light CP′ due to refraction is less likely to occur, and the stray light G (see FIG. 3) that passes through the reflective polarizing plate 54 is less likely to be generated. Therefore, a degradation in quality of display to be seen can be inhibited. Note that the incident angle of effective light that is incident on the component 41 from the air is relatively small, thus the influence of refraction is small.

Here, appropriate ranges of the refractive indices of the component 41, the component 42, and the optical adhesive 43 are described. A material having a high visible-light transmittance is used for the component 41 and the component 42, and glass or a resin is typically used. These materials have refractive indices of approximately 1.4 to 2.0 with respect to visible light, and a material with a refractive index substantially equal to those of the above materials is used for the optical adhesive.

As illustrated in FIG. 3, when light is incident from the air (nₐ=1), a difference between refractive indices is greater than or equal to 0.4, and thus stray light is generated. Accordingly, in order to reduce the generation amount of stray light, the difference between the refractive index n₄₁ of the component 41 and the refractive index n₄₂ of the component 42 is less than or equal to 0.3, preferably less than or equal to 0.2, further preferably less than or equal to 0.1. The range can be found to be appropriate also from the calculation results in FIG. 4A, FIG. 4B, FIG. 5A, and FIG. 5B. Note that when the refractive index n₄₃ of the optical adhesive 43 is taken into consideration, the difference between the maximum value and the minimum value of the refractive index n₄₁, the refractive index n₄₂, and the refractive index n₄₃ is 0.3 or less, preferably 0.2 or less, further preferably 0.1 or less.

The optical unit 45 needs to be configured to collect light. Therefore, the optical unit 45 needs to be composed of a combination of components such as a convex lens and a concave mirror to have positive power as a whole.

Although the component 42 of the optical unit 45 has a convex surface on the light emission side and functions as a convex lens in the example illustrated in FIG. 1, a large incident angle leads to easy loss of the polarization state and generation of a large amount of stray light, as can be seen from the calculation results in FIG. 4A.

Therefore, in order to inhibit stray light, the light emission side of the component 42 is preferably as flat as possible so that the incident angle does not become large. By minimizing the convex lens function and increasing the curvature of a reflective surface of the layer 52, the optical unit 45 has higher positive power as a whole.

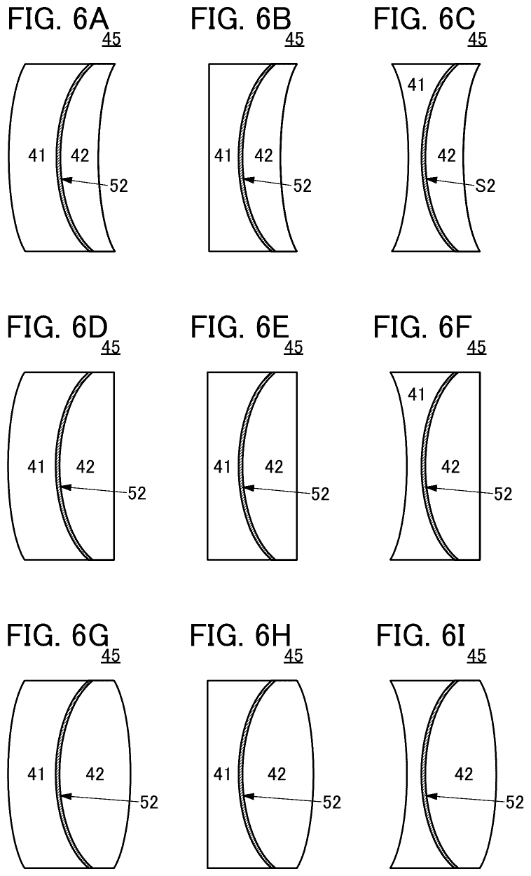

As long as the curvature of the reflective surface of the layer 52 is increased so that the optical unit 45 can have positive power as a whole, an component 1 and an component 2 are not limited to the forms illustrated in FIG. 1. FIG. 6A to FIG. 6I each illustrate typical form applicable to the optical unit 45. Note that the form of the optical unit 45 illustrated in FIG. 1 corresponds to FIG. 6H.

Table 1 shows the forms of the component 41 and the component 42 illustrated in FIG. 6A to FIG. 6I. Although form is described as a lens in Table 1, the combination of the component 41 and the component 42 does not function as lenses in some cases. Even in the case where power is negative, slightly positive, or not present in the combination of the component 41 and the component 42, the optical unit 45 can have strongly positive power as a whole by increasing the curvature of the layer 52. Note that form other than those shown in Table 1 may be employed as long as positive power can be obtained by increasing the curvature of the layer 52.

TABLE 1

| A | | B | | C | |
|---|---|---|---|---|---|
| Element 41 | Element 42 | Element 41 | Element 42 | Element 41 | Element 42 |
| Concave | Convex | Plano- | Convex | Biconcave | Convex |
| meniscus lens | meniscus lens | concave lens | meniscus lens | lens | meniscus lens |
| D | | E | | F | |
| Element 41 | Element 42 | Element 41 | Element 42 | Element 41 | Element 42 |
| Concave | Plano- | Plano- | Plano- | Biconcave | Plano- |
| meniscus lens | convex lens | concave lens | convex lens | lens | convex lens |
| G | | H | | I | |
| Element 41 | Element 42 | Element 41 | Element 42 | Element 41 | Element 42 |
| Concave | Biconvex | Plano- | Biconvex | Biconcave | Biconvex |
| meniscus lens | lens | concave lens | lens | lens | lens |

The optical units 45 illustrated in FIG. 6A to FIG. 6I have the following features and can be selected as appropriate depending on the application.

Examples of an index of field curvature include the Petzval sum which is determined from the refractive indices and the focal lengths of lenses (the component 41 and the component 42). When the Petzval sum is 0, the image plane is flat, which is preferable for a lens system. To satisfy this, the refractive index or the focal length needs to be negative. However, since the refractive index does not becomes negative, a concave lens with a negative focal length is preferably used. Therefore, to inhibit field curvature, it can be said that the optical unit 45 having any of the structures illustrated in FIG. 6A, FIG. 6B, FIG. 6C, FIG. 6F, and FIG. 6I is preferably used.

Refraction involves chromatic aberration, and combining positive power and negative power is effective in correcting the chromatic aberration. Even in the case where the incident surface is flat, the chromatic aberration occurs unless the incident light is a parallel beam. Thus, combining surfaces that can mutually correct (a convex surface and a concave surface) is effective. Therefore, to inhibit the chromatic aberration, it can be said that the optical unit 45 having any of the structures illustrated in FIG. 6A, FIG. 6B, FIG. 6F, and FIG. 6I is preferably used.

To put it simply, the stronger the positive power is, the shorter the focal length can be, allowing the entire optical system to be more compact. The optical unit 45, where most of the positive power depends on the half mirror (the reflective surface of the layer 52), can have a shorter focal length when a convex surface is provided. Thus, to increase positive power even slightly, it can be said that the optical unit 45 having any of the structures illustrated in FIG. 6A, FIG. 6D, FIG. 6G, FIG. 6H, and FIG. 6I is preferably used.

A catadioptric system of one embodiment of the present invention requires a reflective polarizing plate. The reflective polarizing plate has a film-like shape, and considering that it is directly attached to the optical unit 45, a flat adhesive surface is effective. Thus, in terms of easy fabrication, it can be said that the optical unit 45 having any of the structures illustrated in FIG. 6D, FIG. 6E, FIG. 6F, and FIG. 6I is preferably used.

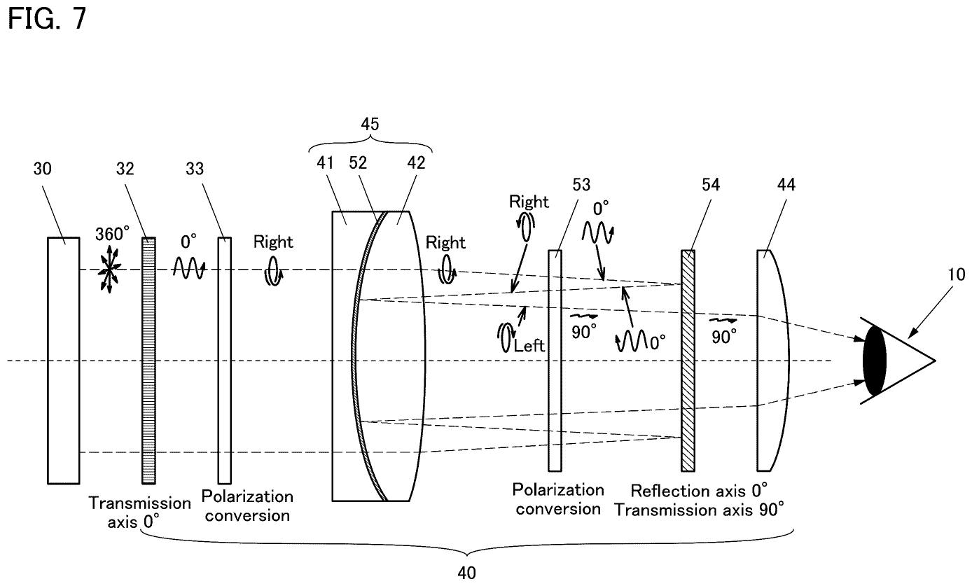

Next, the function of the entire optical device 40 of one embodiment of the present invention and the function of each of components are described with reference to FIG. 7. Note that the effect of one embodiment of the present invention can be obtained also by placing the components included in the optical device 40 to be apart from each other as in FIG. 7.

Part of light emitted from the display panel 30 passes through the linear polarizing plate 32, the retardation plate 33, the optical unit 45 (the component 41, the layer 52 (half mirror), and the component 42), and the retardation plate 53, and is reflected by the reflective polarizing plate 54. The light reflected by the reflective polarizing plate 54 passes through the retardation plate 53 and the component 42 and is reflected again by the layer 52. The light reflected by the layer 52 passes through the component 42, the retardation plate 53, the reflective polarizing plate 54, and the lens 44, and then is condensed and incident on the eye 10.

By repeating reflection in the optical device 40 in this manner, the optical path length can be secured; thus, an optical system with a short focal length can be achieved.

A liquid crystal panel including a liquid crystal element, an organic EL panel including an organic EL element, an LED panel including a micro LED, or the like can be used as the display panel 30. In particular, an organic EL panel, which is of self-luminous type and with which a high-resolution display portion is easily formed, is preferably used. In this specification and the like, a light-emitting diode whose chip area is less than or equal to 10000 μm² is referred to as a micro LED. Note that the LED panel is not limited to the micro LED; for example, a light-emitting diode whose chip area is greater than 10000 μm² and less than or equal to 1 mm² (also referred to as a mini LED) may be used. In this embodiment, an example in which an organic EL panel is used as the display panel 30 is described.

The linear polarizing plate 32 can extract one linearly polarized light from light oscillating in 360° all directions. Note that although a description is given in this embodiment on the assumption that the transmission axis of the linear polarizing plate 32 is 0°, 0° is not an absolute value but a reference value. That is, the polarization plane of the linearly polarized light extracted by the linear polarizing plate 32 is regarded as 0°. Therefore, for example, 90° linearly polarized light in this embodiment refers to linearly polarized light obtained by rotating the polarization plane of the linearly polarized light extracted by the linear polarizing plate 32 by 90°.

The retardation plate 33 has a function of converting linearly polarized light into circularly polarized light. Here, a λ/4 plate (a quarter-wave plate) is used as the retardation plate 33. The λ/4 plate is overlaid with the linear polarizing plate 32 such that the angle of the slow axis of the λ/4 plate with respect to the axis of the linearly polarized light emitted from the linear polarizing plate 32 becomes 45°, whereby right-handed circularly polarized light (right-circularly polarized light) is obtained. The λ/4 plate is overlaid with the linear polarizing plate 32 such that the angle of the slow axis of the λ/4 plate with respect to the axis of the linearly polarized light emitted from the linear polarizing plate 32 becomes −45°, whereby left-handed circularly polarized light (left-circularly polarized light) is obtained. In one embodiment of the present invention, either right-circularly polarized light or left-circularly polarized light may be used as long as the combination with the characteristics of the reflective polarizing plate 54 described later is appropriate.

For the optical unit 45, the above description can be referred to.

The retardation plate 53 has a function of reversibly converting linearly polarized light and circularly polarized light. The λ/4 plate (the quarter-wave plate) can be used as the retardation plate 53 as well as the retardation plate 33.

The reflective polarizing plate 54 can transmit linearly polarized light that oscillates in the same direction as the transmission axis, and can reflect linearly polarized light that is orthogonal to the transmission axis. For example, a wire grid polarizing plate or a dielectric multilayer film can be used as the reflective polarizing plate.

A convex lens can be used as the lens 44. Although FIG. 7 illustrates an example where one plano-convex lens is used as the lens 44, the lens 44 is not limited thereto. For example, the lens 44 may be formed of a plurality of plano-convex lenses. In addition, a biconvex lens may be used as the lens 44. Alternatively, the lens 44 can be formed by combining lenses selected from a biconvex lens, a plano-convex lens, a biconcave lens, a plano-concave lens, a convex meniscus lens, and a concave meniscus lens. The lens 44 is not limited to a spherical lens and may be an aspherical lens.

The optical device 40 may be provided with a lens other than the lens 44.

Details of the polarization state in the optical device 40 described above are described with reference to the optical path illustrated in FIG. 7.

Light oscillating in 360° all directions that is emitted from the display panel 30 is incident on the linear polarizing plate 32. The transmission axis of the linear polarizing plate 32 is 0°, and 0° linearly polarized light is emitted from the linear polarizing plate 32. Note that in the case where a liquid crystal panel is used as the display panel, the polarization plane of light emitted from the liquid crystal panel is preferably made parallel to the transmission axis of the linear polarizing plate 32 in order to use light effectively.

The 0° linearly polarized light emitted from the linear polarizing plate 32 is converted into right-circularly polarized light by the retardation plate 33. The right-circularly polarized light emitted from the retardation plate 33 passes through the optical unit 45, is incident on the retardation plate 53, and is converted into 0° linearly polarized light. The 0° linearly polarized light emitted from the retardation plate 53 is reflected by the reflective polarizing plate 54 whose reflection axis is 0°, and the light is incident on the retardation plate 53 to be converted into right-circularly polarized light.

The right-circularly polarized light emitted from the retardation plate 53 passes through the component 42, is reflected by the layer 52, and is converted into the left-circularly polarized light having the opposite rotating direction. The left-circularly polarized light inverted by the layer 52 passes through the component 42, and the light is incident on the retardation plate 53 and is converted into 90° linearly polarized light. The 90° linearly polarized light emitted from the retardation plate 53 passes through the reflective polarizing plate 54 whose transmission axis is 90° and the lens 44, and is incident on the eye 10.

With the use of linearly polarized light, circularly polarized light, the half mirror (the layer 52), and the reflective polarizing plate in this manner, reflection and transmission can be selectively performed. Therefore, the optical path length can be secured in a limited space, and the focal length of the optical device can be shortened.

Although the right-circularly polarized light is used as light incident on the optical unit 45 in the above example, the left-circularly polarized light may also be used.

The structure of each of the display panel 30 and the optical device 40 illustrated in FIG. 7 is an example, and other structures can also be employed.

Although the structure in which refraction of light after polarization conversion is inhibited is described above, a structure in which refracted light is converted into polarized light may be employed.

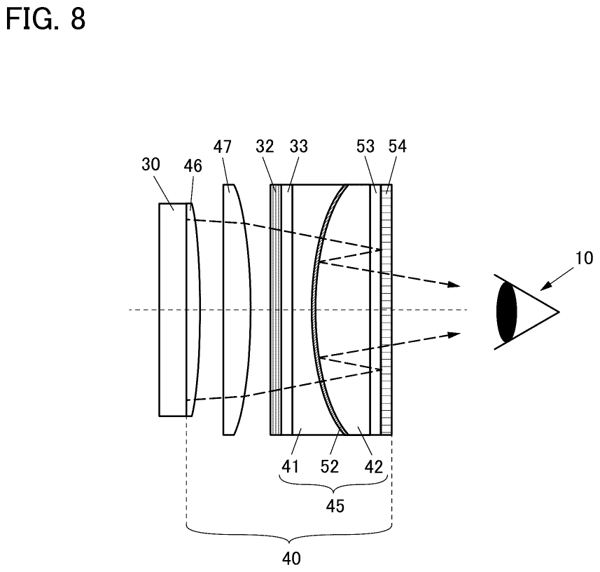

In a structure illustrated in FIG. 8, the optical unit 45 has the structure illustrated in FIG. 6E, and a lens 46 and a lens 47 are provided between the display panel 30 and the optical unit 45. The linear polarizing plate 32 and the retardation plate 33 can be provided on one surface of the optical unit 45 (a side on which light is incident from the display panel 30), and the retardation plate 53 and the reflective polarizing plate 54 can be provided on the other surface (a side from which light is emitted in the direction of the eye 10). In this case, the linear polarizing plate 32, the retardation plate 33, the optical unit 45, the retardation plate 53, and the reflective polarizing plate 54 can be bonded to each other with an optical adhesive.

In this structure, light that has passed through the lens 46 and the lens 47 is polarized by the linear polarizing plate 32 and the retardation plate 33. That is, non-polarized light is refracted and then polarized. Note that all the structures illustrated in FIG. 6A to FIG. 6I can be employed for the optical unit 45.

In the optical unit 45 illustrated in FIG. 6E, the combination of the component 41 and the component 42 hardly functions as a lens, and a reflective surface of the layer 52 has a light collecting function. That is, non-polarized light is refracted and then converted into polarized light, and the polarized light is hardly refracted until being incident on the eye 10. Thus, as in the structure illustrated in FIG. 1, stray light due to refraction can be inhibited.

In order to widen the field of view, increasing the magnification of a lens is effective, and it is preferable to use a high-refractive-index resin lens whose interface with air easily allows large refraction. A resin lens is preferably used in terms of reducing the weight of the optical device. However, a resin lens has problems of interfacial refraction and material birefringence, which increases stray light due to refraction.

In the structure illustrated in FIG. 8, a refraction problem and a magnification problem can be considered separately; the optical unit 45 does not have a lens function and a resin lens with a high refractive index (e.g., n is greater than or equal to 1.7) is provided outside the optical unit 45 in order to increase the magnification. The resin lens can be used as the lens 46 and the lens 47. In order to use positive power of the layer 52 efficiently, the lens 46 and the lens 47 are preferably provided between the display panel 30 and the optical unit 45.

A convex lens can be used as the lens 46 and the lens 47. Although FIG. 8 illustrates an example where plano-convex lenses are used as the lens 46 and the lens 47, the lens 46 and the lens 47 are not limited thereto. For example, biconvex lenses may be used as the lens 46 and the lens 47. Alternatively, the lens 46 and the lens 47 may be a combination of lenses selected from a biconvex lens, a plano-convex lens, a biconcave lens, a plano-concave lens, a convex meniscus lens, and a concave meniscus lens.

The lens 46 and the lens 47 are not limited to spherical lenses and may also be aspherical lenses. Alternatively, one of the lens 46 and the lens 47 can be omitted. The optical device 40 may be provided with a lens other than the lens 46 and the lens 47.

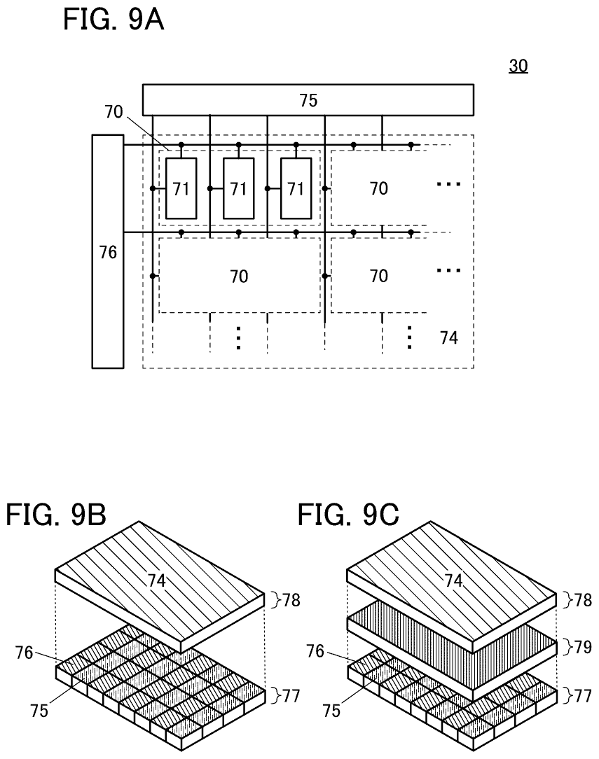

FIG. 9A is a diagram illustrating the display panel 30 included in the electronic device according to one embodiment of the present invention. The display panel 30 includes a pixel array 74, a circuit 75, and a circuit 76. The pixel array 74 includes pixels 70 arranged in a column direction and a row direction.

The pixel 70 can include a plurality of subpixels 71. The subpixel 71 has a function of emitting light for display.

Note that in this specification, although the minimum unit in which an independent operation is performed in one “pixel” is defined as a “subpixel” in the description for convenience, a “pixel” may be replaced with a “region” and a “subpixel” may be replaced with a “pixel.”

The subpixel 71 includes alight-emitting device that emits visible light. An EL element such as an OLED (Organic Light Emitting Diode) or a QLED (Quantum-dot Light Emitting Diode) is preferably used as the light-emitting device. As a light-emitting substance contained in the EL element, a substance that emits fluorescent light (a fluorescent material), a substance that emits phosphorescent light (a phosphorescent material), a substance that exhibits thermally activated delayed fluorescence (a thermally activated delayed fluorescent (TADF) material), an inorganic compound (a quantum dot material or the like), and the like can be given. An LED such as a micro-LED (Light Emitting Diode) can also be used as the light-emitting device.

The circuit 75 and the circuit 76 are driver circuits for driving the subpixel 71. The circuit 75 can have a function of a source driver circuit, and the circuit 76 can have a function of a gate driver circuit. A shift register circuit or the like can be used as each of the circuit 75 and the circuit 76, for example.

Note that as illustrated in FIG. 9B, a structure where the circuit 75 and the circuit 76 are provided in a layer 77, the pixel array 74 is provided in a layer 78, and the layer 77 and the layer 78 overlap with each other may be employed. This structure enables a display device with a narrow bezel to be formed.

In addition, when the driver circuits are provided below the pixel array 74, wiring length can be shortened and wiring capacitance can be reduced. Accordingly, a display panel capable of a high-speed operation with low power consumption can be provided.

In addition, when each of the circuit 75 and the circuit 76 is divided and arranged as illustrated in FIG. 9B, part of the pixel array 74 can be driven. For example, part of image data in the pixel array 74 can be rewritten. Furthermore, part of the pixel array 74 can be operated at different operating frequency.

The layout and area of the circuit 75 and the circuit 76 illustrated in FIG. 9B are examples and can be changed as appropriate. In addition, parts of the circuit 75 and the circuit 76 can be formed in the same layer as the pixel array 74. Furthermore, a circuit such as a memory circuit, an arithmetic circuit, or a communication circuit may be provided in the layer 77.

In this structure, for example, the layer 77 can be provided on a single crystal silicon substrate, the circuit 75 and the circuit 76 can be formed with transistors including silicon in channel formation regions (hereinafter Si transistors), and pixel circuits included in the pixel array 74 provided in the layer 78 can be formed with transistors including a metal oxide in channel formation regions (hereinafter OS transistors). An OS transistor can be formed with a thin film and can be formed to be stacked over a Si transistor.

Note that as illustrated in FIG. 9C, a structure where a layer 79 including OS transistors is provided between the layer 77 and the layer 78 may be employed. Some of the pixel circuits included in the pixel array 74 in the layer 79 can be provided with OS transistors. Alternatively, some of the circuit 75 and the circuit 76 can be provided with OS transistors. Alternatively, some of the circuits that can be provided in the layer 77, such as a memory circuit, an arithmetic circuit, and a communication circuit, can be provided with OS transistors.

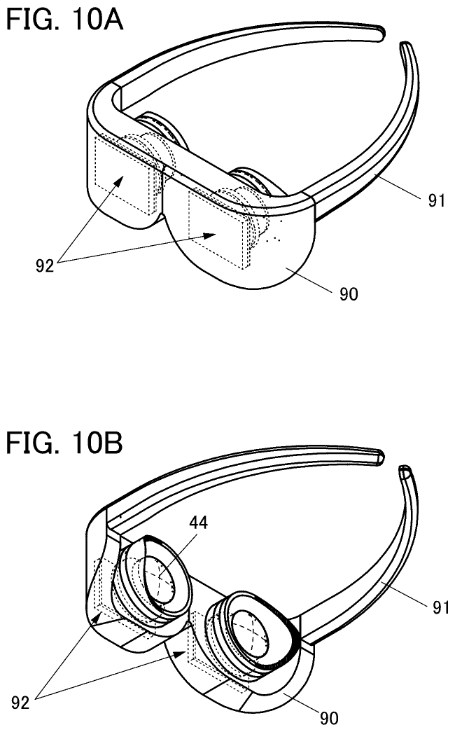

FIG. 10A and FIG. 10B are diagrams illustrating an example of a glasses-type device including the display panel 30 and the optical device 40 which are illustrated in FIG. 1. Here, a combination of the display panel 30 and the optical device 40 is illustrated by dashed lines as a display unit 92. The glasses-type device includes two display units 92 and is sometimes called VR glasses depending on the usage.

The two display units 92 are incorporated in a housing 90 so that surfaces of the lenses 44 are exposed on the inner side. One of the display units 92 is for a right eye, the other of the display units 92 is for a left eye, and each of the display units 92 displays an image using parallax, so that the image can be perceived as a three-dimensional image.

In addition, the housing 90 or a band 91 may be provided with an input terminal and an output terminal. To the input terminal, a cable for supplying a video signal from a video output device or the like, power for charging a battery provided in the housing 90, or the like can be connected. The output terminal can function as, for example, an audio output terminal to which earphones, headphones, or the like can be connected. Note that in the case where audio data can be output by wireless communication or sound is output from an external video output device, the audio output terminal is not necessarily provided.

In addition, a wireless communication module, a memory module, and the like may be provided inside the housing 90 or the band 91. Content to be watched can be downloaded via wireless communication using the wireless communication module and can be stored in the memory module. This enables a user to watch the downloaded content offline.

In addition, a gaze sensor may be provided in the housing 90. For example, operation buttons for power-on, power-off, sleep, volume control, channel change, menu display, selection, decision, and back, and operation buttons for play, stop, pause, fast forward, and fast backward of moving images are displayed and visually recognized, so that the respective operations can be performed.

With the use of the optical device 40 according to one embodiment of the present invention for the glasses-type device, a small and thin electronic device with low power consumption and high reliability can be achieved.

At least part of this embodiment can be implemented in combination with the other embodiments and examples described in this specification as appropriate.

### Embodiment 2

In this embodiment, structure examples of a display panel that can be employed for the electronic device according to one embodiment of the present invention will be described. A display panel described below as an example can be employed for the display panel 30 in Embodiment 1.

One embodiment of the present invention is a display panel including light-emitting elements (also referred to as light-emitting devices). The display panel includes two or more pixels exhibiting different colors. The pixels include light-emitting elements. The light-emitting elements each include a pair of electrodes and an EL layer therebetween. The light-emitting elements are preferably organic EL elements (organic electroluminescent elements). Two or more light-emitting elements emitting different colors include EL layers including different light-emitting materials. For example, when three kinds of light-emitting elements that emit red (R), green (G), and blue (B) light are included, a full-color display panel can be achieved.

In the case of manufacturing a display panel including a plurality of light-emitting elements emitting different colors, at least layers (light-emitting layers) including light-emitting materials each need to be formed in an island shape. In the case of separately forming part or the whole of an EL layer, a method for forming an island-shaped organic film by an evaporation method using a shadow mask such as a metal mask is known. However, this method causes a deviation from the designed shape and position of the island-shaped organic film due to various influences such as the accuracy of the metal mask, the positional deviation between the metal mask and a substrate, a warp of the metal mask, and expansion of the outline of a formed film due to vapor scattering, for example; therefore, it is difficult to achieve a high resolution and a high aperture ratio of the display panel. In addition, the outline of the layer might blur during evaporation, so that the thickness of an end portion might be reduced. That is, the thickness of an island-shaped light-emitting layer might vary from place to place. In addition, in the case of manufacturing a display panel with a large size, a high definition, or a high resolution, a manufacturing yield might be reduced because of low dimensional accuracy of the metal mask and deformation due to heat or the like. Thus, a measure has been taken for a pseudo increase in resolution (also referred to as pixel density) by employing unique pixel arrangement such as PenTile arrangement.

Note that in this specification and the like, the term “island shape” refers to a state where two or more layers formed using the same material in the same step are physically separated from each other. For example, the term “island-shaped light-emitting layer” refers to a state where the light-emitting layer and its adjacent light-emitting layer are physically separated from each other.

In one embodiment of the present invention, fine patterning of EL layers is performed by a photolithography method without using a shadow mask such as a fine metal mask (FMM). Accordingly, it is possible to achieve a display panel with a high resolution and a high aperture ratio, which has been difficult to achieve. Moreover, since the EL layers can be formed separately, it is possible to achieve a display panel that performs extremely clear display with high contrast and high display quality. Note that, fine patterning of the EL layers may be performed using both a metal mask and a photolithography method, for example.

In addition, part or the whole of the EL layer can be physically divided from each other. This can inhibit leakage current flowing between adjacent light-emitting elements through a layer (also referred to as a common layer) shared by the light-emitting elements. Thus, it is possible to prevent unintended light emission due to crosstalk, so that a display panel with extremely high contrast can be achieved. In particular, a display panel having high current efficiency at low luminance can be achieved.

Note that in one embodiment of the present invention, the display panel can also be obtained by combining a light-emitting element that emits the white light with a color filter. In that case, light-emitting elements having the same structure can be used as light-emitting elements provided in pixels (subpixels) that emit light of different colors, which allows all the layers to be common layers. In addition, part or the whole of the EL layer may be divided from each other in a step using a photolithography method. Thus, leakage current through the common layer is inhibited; therefore, a high-contrast display panel can be achieved. In particular, when an element has a tandem structure where a plurality of light-emitting layers are stacked with a highly conductive intermediate layer therebetween, leakage current through the intermediate layer can be effectively prevented, so that a display panel with high luminance, high resolution, and high contrast can be achieved.

In the case where the EL layer is processed by a photolithography method, part of the light-emitting layer is sometimes exposed to cause degradation. Thus, an insulating layer covering at least a side surface of the island-shaped light-emitting layer is preferably provided. The insulating layer may cover part of a top surface of an island-shaped EL layer. For the insulating layer, a material having a barrier property against water and oxygen is preferably used. For example, an inorganic insulating film that is less likely to diffuse water or oxygen can be used. This can inhibit deterioration of the EL layer and can achieve a highly reliable display panel.

Moreover, between two adjacent light-emitting elements, there is a region (a concave portion) where none of the EL layers of the light-emitting elements is provided. In the case where a common electrode or a common electrode and a common layer are formed to cover the concave portion, a phenomenon where the common electrode is divided by a step at an end portion of the EL layer (such a phenomenon is also referred to as disconnection) might occur, which might cause insulation of the common electrode over the EL layer. In view of this, a structure is preferably employed in which a local gap between the two adjacent light-emitting elements is filled with a resin layer functioning as a planarization film (such a structure is also referred to as LFP: Local Filling Planarization). The resin layer has a function of a planarization film. This structure can inhibit disconnection of the common layer or the common electrode and can achieve a highly reliable display panel.

More specific structure examples of the display panel according to one embodiment of the present invention will be described below with reference to drawings.

### Structure Example 1

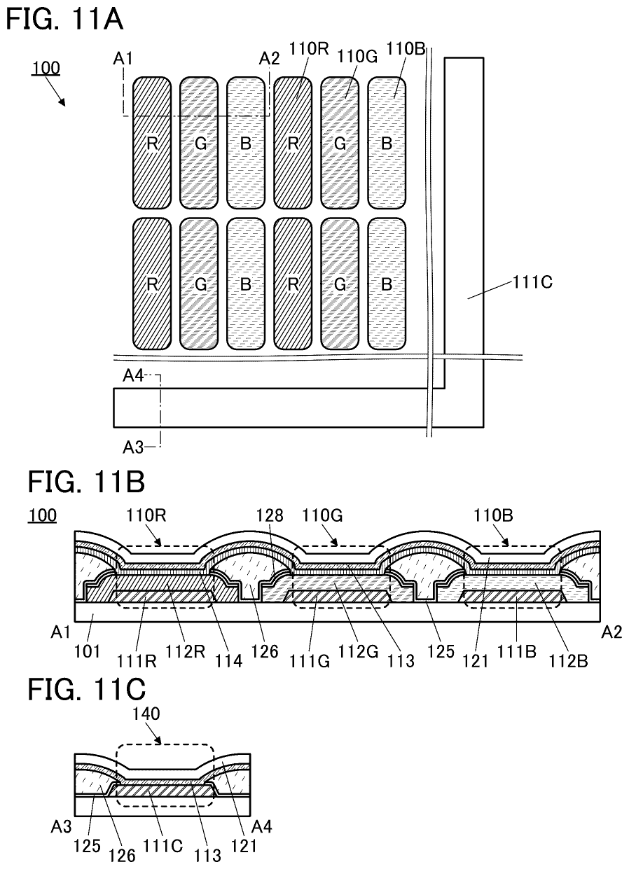

FIG. 11A is a schematic top view of a display panel 100 according to one embodiment of the present invention. The display panel 100 includes, over a substrate 101, a plurality of light-emitting elements 110R exhibiting red, a plurality of light-emitting elements 110G exhibiting green, and a plurality of light-emitting elements 110B exhibiting blue. In FIG. 11A, light-emitting regions of the light-emitting elements are denoted by R, G, and B to easily differentiate the light-emitting elements.

The light-emitting elements 110R, the light-emitting elements 110G, and the light-emitting elements 110B are each arranged in a matrix. FIG. 11A illustrates what is called a stripe arrangement, in which light-emitting elements of the same color are arranged in one direction. Note that an arrangement method of the light-emitting elements is not limited thereto; an arrangement method such as S-stripe arrangement, delta arrangement, Bayer arrangement, or zigzag arrangement may be employed, or PenTile arrangement, diamond arrangement, or the like can also be used.

As each of the light-emitting elements 110R, the light-emitting elements 110G, and the light-emitting elements 110B, an OLED (Organic Light Emitting Diode) or a QLED (Quantum-dot Light Emitting Diode) is preferably used, for example. As the light-emitting substance contained in the EL element, not only an organic compound but also an inorganic compound (a quantum dot material or the like) can be used.

FIG. 11A also illustrates a connection electrode 111C that is electrically connected to a common electrode 113. The connection electrode 111C is supplied with a potential (e.g., an anode potential or a cathode potential) that is to be supplied to the common electrode 113. The connection electrode 111C is provided outside a display region where the light-emitting elements 110R and the like are arranged.

The connection electrode 111C can be provided along the outer periphery of the display region. For example, the connection electrode 111C may be provided along one side of the outer periphery of the display region, or the connection electrode 111C may be provided along two or more sides of the outer periphery of the display region. That is, in the case where the display region has a rectangular top surface shape, the top surface shape of the connection electrode 111C can be a band shape (a rectangle), an L shape, a U shape (a square bracket shape), a quadrangular shape, or the like. Note that in this specification and the like, atop surface shape refers to a shape in a plan view, i.e., a shape seen from above.

FIG. 11B and FIG. 11C are schematic cross-sectional views corresponding to the dashed-dotted line A1-A2 and the dashed-dotted line A3-A4, respectively, in FIG. 11A. FIG. 11B is a schematic cross-sectional view of the light-emitting element 110R, the light-emitting element 110G, and the light-emitting element 110B, and FIG. 1C is a schematic cross-sectional view of a connection portion 140 where the connection electrode 111C and the common electrode 113 are connected to each other.

The light-emitting element 110R includes a pixel electrode 111R, an organic layer 112R, a common layer 114, and the common electrode 113. The light-emitting element 110G includes a pixel electrode 111G, an organic layer 112G, the common layer 114, and the common electrode 113. The light-emitting element 110B includes a pixel electrode 111B, an organic layer 112B, the common layer 114, and the common electrode 113. The common layer 114 and the common electrode 113 are provided to be shared by the light-emitting element 110R, the light-emitting element 110G, and the light-emitting element 110B.

The organic layer 112R included in the light-emitting element 110R contains at least a light-emitting organic compound that emits red light. The organic layer 112G included in the light-emitting element 110G contains at least a light-emitting organic compound that emits green light. The organic layer 112B included in the light-emitting element 110B contains at least a light-emitting organic compound that emits blue light. Each of the organic layer 112R, the organic layer 112G, and the organic layer 112B can also be referred to as an EL layer and includes at least a layer containing a light-emitting substance (a light-emitting layer).

Hereinafter, the term “light-emitting element 110” is sometimes used to describe matters common to the light-emitting element 110R, the light-emitting element 110G, and the light-emitting element 1101B. Similarly, in the description of matters common to components that are distinguished from each other using alphabets, such as the organic layer 112R, the organic layer 112G, and the organic layer 112B, reference numerals without alphabets are sometimes used.

Each of the organic layer 112 and the common layer 114 can independently include one or more of an electron-injection layer, an electron-transport layer, a hole-injection layer, and a hole-transport layer. For example, it is possible to employ a structure where the organic layer 112 has a stacked-layer structure of a hole-injection layer, a hole-transport layer, a light-emitting layer, and an electron-transport layer from the pixel electrode 111 side and the common layer 114 includes an electron-injection layer.

The pixel electrode 111R, the pixel electrode 111G, and the pixel electrode 111B are provided for the respective light-emitting elements. In addition, the common electrode 113 and the common layer 114 are each provided as a continuous layer shared by the light-emitting elements. A conductive film having a light-transmitting property with respect to visible light is used for either the pixel electrodes or the common electrode 113, and a conductive film having a reflective property is used for the other. When the pixel electrodes have light-transmitting properties and the common electrode 113 has a reflective property, a bottom-emission display panel can be obtained. In contrast, when the pixel electrodes have reflective properties and the common electrode 113 has a light-transmitting property, a top-emission display panel can be obtained. Note that when both the pixel electrodes and the common electrode 113 have light-transmitting properties, a dual-emission display panel can be obtained.

A protective layer 121 is provided over the common electrode 113 to cover the light-emitting element 110R, the light-emitting element 110G, and the light-emitting element 110B. The protective layer 121 has a function of preventing diffusion of impurities such as water into each light-emitting element from the above.

An end portion of the pixel electrode 111 preferably has a tapered shape. In the case where the end portion of the pixel electrode 111 has a tapered shape, the organic layer 112 that is provided along the end portion of the pixel electrode 111 can also have a tapered shape. When the end portion of the pixel electrode 111 has a tapered shape, coverage with the organic layer 112 provided beyond the end portion of the pixel electrode 111 can be increased. Furthermore, when the side surface of the pixel electrode 111 has a tapered shape, a foreign matter (for example, also referred to as dust or particles) in a manufacturing step is easily removed by processing such as cleaning, which is preferable.

Note that in this specification and the like, a tapered shape indicates a shape in which at least part of a side surface of a structure is inclined to a substrate surface. For example, a tapered shape preferably includes a region where an angle formed between the inclined side surface and the substrate surface (such an angle is also referred to as a taper angle) is less than 90°.

The organic layer 112 is processed into an island shape by a photolithography method. Thus, an angle formed between a top surface and a side surface of an end portion of the organic layer 112 is approximately 90°. By contrast, an organic film formed using an FMM (Fine Metal Mask) or the like has a thickness that tends to gradually decrease with decreasing distance to the end portion, and the top surface has a slope shape in the range of greater than or equal to 1 μm and less than or equal to 10 μm, for example; thus, such an organic film has a shape whose top and side surfaces cannot be easily distinguished from each other.

An insulating layer 125, a resin layer 126, and a layer 128 are included between two adjacent light-emitting elements.

Between two adjacent light-emitting elements, the side surfaces of the organic layers 112 are provided to face each other with the resin layer 126 therebetween. The resin layer 126 is positioned between the two adjacent light-emitting elements and is provided to fill regions between end portions of the organic layers 112 and between the two organic layers 112. The resin layer 126 has a top surface with a smooth convex shape, and the common layer 114 and the common electrode 113 are provided to cover the top surface of the resin layer 126.

The resin layer 126 functions as a planarization film that fills a gap positioned between two adjacent light-emitting elements. Providing the resin layer 126 can prevent a phenomenon in which the common electrode 113 is divided by a step at an end portion of the organic layer 112 (such a phenomenon is also referred to as disconnection) from occurring and the common electrode over the organic layer 112 from being insulated.

An insulating layer containing an organic material can be suitably used as the resin layer 126. For the resin layer 126, an acrylic resin, a polyimide resin, an epoxy resin, an imide resin, a polyamide resin, a polyimide-amide resin, a silicone resin, a siloxane resin, a benzocyclobutene-based resin, a phenol resin, a precursor of these resins, or the like can be used, for example. For the resin layer 126, an organic material such as polyvinyl alcohol (PVA), polyvinylbutyral, polyvinylpyrrolidone, polyethylene glycol, polyglycerin, pullulan, water-soluble cellulose, or an alcohol-soluble polyamide resin may be used.

Alternatively, a photosensitive resin can be used for the resin layer 126. A photoresist may be used for the photosensitive resin. As the photosensitive resin, a positive photosensitive material or a negative photosensitive material can be used.

The resin layer 126 may include a material absorbing visible light. For example, the resin layer 126 itself may be made of a material absorbing visible light, or the resin layer 126 may include a pigment absorbing visible light. For example, for the resin layer 126, it is possible to use a resin that can be used as a color filter transmitting red, blue, or green light and absorbing other light, a resin that contains carbon black as a pigment and functions as a black matrix, or the like.

The insulating layer 125 is provided in contact with the side surface of the organic layers 112. In addition, the insulating layer 125 is provided to cover an upper end portion of the organic layer 112. Furthermore, part of the insulating layer 125 is provided in contact with the top surface of the substrate 101.

The insulating layer 125 is positioned between the resin layer 126 and the organic layer 112 and functions as a protective film for preventing contact between the resin layer 126 and the organic layer 112. When the organic layer 112 and the resin layer 126 are in contact with each other, the organic layer 112 might be dissolved in an organic solvent or the like used at the time of forming the resin layer 126. Therefore, the insulating layer 125 is provided between the organic layer 112 and the resin layer 126 to protect the side surfaces of the organic layer 112.

An insulating layer including an inorganic material can be used for the insulating layer 125. For the insulating layer 125, an inorganic insulating film such as an oxide insulating film, a nitride insulating film, an oxynitride insulating film, or a nitride oxide insulating film can be used, for example. The insulating layer 125 may have either a single-layer structure or a stacked-layer structure. Examples of the oxide insulating film include a silicon oxide film, an aluminum oxide film, a magnesium oxide film, an indium gallium zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon oxide film that is formed by an ALD method is used for the insulating layer 125, it is possible to form the insulating layer 125 that has a small number of pinholes and has an excellent function of protecting the EL layer.

Note that in this specification and the like, oxynitride refers to a material that includes more oxygen than nitrogen in its composition, and nitride oxide refers to a material that includes more nitrogen than oxygen in its composition. For example, silicon oxynitride refers to a material that includes more oxygen than nitrogen in its composition, and silicon nitride oxide refers to a material that includes more nitrogen than oxygen in its composition.

For the formation of the insulating layer 125, a sputtering method, a CVD method, a PLD method, an ALD method, or the like can be used. The insulating layer 125 is preferably formed by an ALD method that provides good coverage.

In addition, a structure may be employed in which a reflective film (e.g., a metal film including one or more selected from silver, palladium, copper, titanium, aluminum, and the like) is provided between the insulating layer 125 and the resin layer 126 so that light emitted from the light-emitting layer is reflected by the reflective film. This can improve light extraction efficiency.

The layer 128 is a remaining part of a protective layer (also referred to as a mask layer or a sacrificial layer) for protecting the organic layer 112 during etching of the organic layer 112. For the layer 128, a material that can be used for the insulating layer 125 can be used. It is particularly preferable to use the same material for the layer 128 and the insulating layer 125 because an apparatus or the like for processing can be used in common.

In particular, since a metal oxide film such as an aluminum oxide film or a hafnium oxide film or an inorganic insulating film such as a silicon oxide film that is formed by an ALD method has a small number of pinholes, such a film has an excellent function of protecting the EL layer and can be suitably used for the insulating layer 125 and the layer 128.

The protective layer 121 can have, for example, a single-layer structure or a stacked-layer structure including at least an inorganic insulating film. Examples of the inorganic insulating film include an oxide film and a nitride film, such as a silicon oxide film, a silicon oxynitride film, a silicon nitride oxide film, a silicon nitride film, an aluminum oxide film, an aluminum oxynitride film, and a hafnium oxide film. Alternatively, a semiconductor material or a conductive material such as indium gallium oxide, indium zinc oxide, indium tin oxide, or indium gallium zinc oxide may be used for the protective layer 121.

For the protective layer 121, a stacked film of an inorganic insulating film and an organic insulating film can be used. For example, a structure where an organic insulating film is interposed between a pair of inorganic insulating films is preferable. Furthermore, the organic insulating film preferably functions as a planarization film. This enables the top surface of the organic insulating film to be flat, which results in improved coverage with the inorganic insulating film thereover and a higher barrier property. Moreover, the top surface of the protective layer 121 is flat; therefore, when a component (e.g., a color filter, an electrode of a touch sensor, a lens array, or the like) is provided above the protective layer 121, the component can be less affected by an uneven shape caused by a lower structure, which is preferable.

FIG. 11C illustrates the connection portion 140 in which the connection electrode 111C and the common electrode 113 are electrically connected to each other. In the connection portion 140, an opening portion is provided in the insulating layer 125 and the resin layer 126 over the connection electrode 111C. The connection electrode 111C and the common electrode 113 are electrically connected to each other in the opening portion.

Note that although FIG. 11C illustrates the connection portion 140 in which the connection electrode 111C and the common electrode 113 are electrically connected to each other, the common electrode 113 may be provided over the connection electrode 111C with the common layer 114 therebetween. Particularly in the case where a carrier-injection layer is used as the common layer 114, for example, a material used for the common layer 114 has sufficiently low electrical resistivity and the common layer 114 can be formed to be thin; thus, problems do not arise in many cases even when the common layer 114 is positioned in the connection portion 140. Accordingly, the common electrode 113 and the common layer 114 can be formed with the use of the same shielding mask, so that manufacturing cost can be reduced.

### Structure Example 2

A display panel whose structure is partly different from that of Structure Example 1 is described below. Note that the above description can be referred to for portions common to those in Structure Example 1, and the description is omitted in some cases.

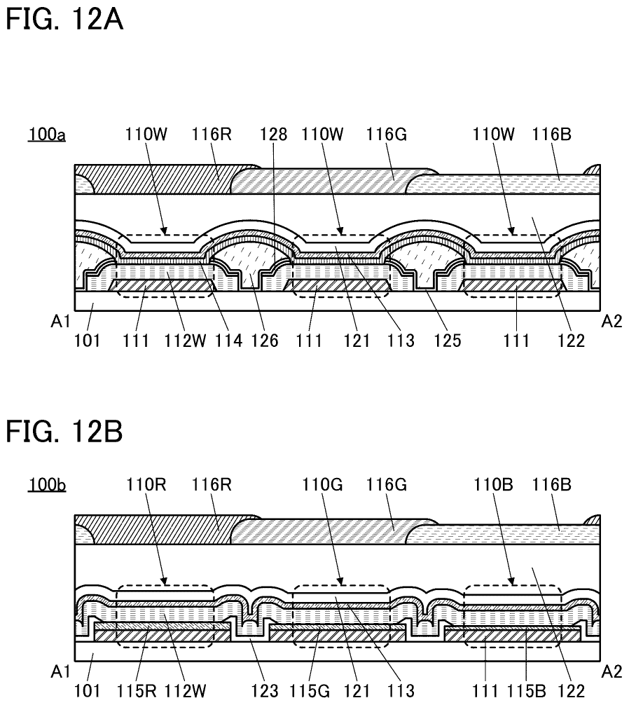

FIG. 12A is a schematic cross-sectional view of a display panel 100a. The display panel 100a is different from the display panel 100 mainly in the structure of the light-emitting element and including a coloring layer.

The display panel 100a includes light-emitting elements 110W that emit white light. The light-emitting elements 110W each include the pixel electrode 111, an organic layer 112W, the common layer 114, and the common electrode 113. The organic layer 112W emits white light. For example, the organic layer 112W can include two or more kinds of light-emitting materials whose emission colors are complementary colors. For example, the organic layer 112W can include a light-emitting organic compound that emits red light, a light-emitting organic compound that emits green light, and a light-emitting organic compound that emits blue light. Alternatively, the organic layer 112W may include a light-emitting organic compound that emits blue light and a light-emitting organic compound that emits yellow light.

The organic layer 112W is divided between two adjacent light-emitting elements 110W. Thus, leakage current flowing between the adjacent light-emitting elements 110W through the organic layer 112W can be inhibited and crosstalk due to the leakage current can be inhibited. Accordingly, the display panel can achieve high contrast and high color reproducibility.

An insulating layer 122 that functions as a planarization film is provided over the protective layer 121, and a coloring layer 116R, a coloring layer 116G, and a coloring layer 116B are provided over the insulating layer 122.

An organic resin film or an inorganic insulating film with a flat top surface can be used for the insulating layer 122. The insulating layer 122 is a formation surface on which the coloring layer 116R, the coloring layer 116G, and the coloring layer 116B are formed; thus, with the flat top surface of the insulating layer 122, the thickness of the coloring layer 116R or the like can be uniform and color purity can be increased. Note that when the thickness of the coloring layer 116R or the like is non-uniform, the amount of light absorption varies depending on a place in the coloring layer 116R, which might decrease the color purity.

### Structure Example 3

FIG. 12B is a schematic cross-sectional view of a display panel 100b.

The light-emitting element 110R includes the pixel electrode 111, a conductive layer 115R, the organic layer 112W, and the common electrode 113. The light-emitting element 110G includes the pixel electrode 111, a conductive layer 115G, the organic layer 112W, and the common electrode 113. The light-emitting element 1101B includes the pixel electrode 111, a conductive layer 115B, the organic layer 112W, and the common electrode 113. The conductive layer 115R, the conductive layer 115G, and the conductive layer 115B each have a light-transmitting property and function as an optical adjustment layer.

A film that reflects visible light is used for the pixel electrode 111 and a film having a property of reflecting and transmitting visible light is used for the common electrode 113, so that a micro resonator (microcavity) structure can be achieved. In that case, by adjusting the thicknesses of the conductive layer 115R, the conductive layer 115G, and the conductive layer 115B to obtain optimal optical path length, light with different wavelengths and increased intensities can be obtained from the light-emitting element 110R, the light-emitting element 110G, and the light-emitting element 110B even when the organic layer 112 that emits white light is used.

Furthermore, the coloring layer 116R, the coloring layer 116G, and the coloring layer 116B are provided on the optical paths of the light-emitting element 110R, the light-emitting element 110G, and the light-emitting element 110B, respectively, so that light with high color purity can be obtained.

In addition, an insulating layer 123 that covers end portions of the pixel electrode 111, the conductive layer 115R, the conductive layer 115G, and the conductive layer 115B is provided. An end portion of the insulating layer 123 preferably has a tapered shape. When the insulating layer 123 is provided, coverage with the organic layer 112W, the common electrode 113, the protective layer 121, and the like provided over the insulating layer 123 can be increased.

The organic layer 112W and the common electrode 113 are each provided as one continuous film shared by the light-emitting elements. Such a structure is preferable because the manufacturing process of the display panel can be greatly simplified.

Here, the end portion of the pixel electrode 111 preferably has a substantially vertical shape. This allows a steep portion to be formed on the surface of the insulating layer 123, and a thin portion can be formed in part of the organic layer 112W that covers the steep portion or part of the organic layer 112W can be divided. Thus, leakage current generated between adjacent light-emitting elements through the organic layer 112W can be inhibited without processing the organic layer 112W by a photolithography method or the like.

The above is the description of the structure example of the display panel.

### [Pixel Layout]

Pixel layouts different from that in FIG. 11A will be mainly described below. There is no particular limitation on the arrangement of light-emitting elements (subpixels), and a variety of methods can be employed.

In addition, examples of a top surface shape of the subpixel include polygons such as a triangle, a tetragon (including a rectangle and a square), and a pentagon; polygons with rounded corners; an ellipse; and a circle. Here, the top surface shape of the subpixel corresponds to a top surface shape of a light-emitting region of the light-emitting element.

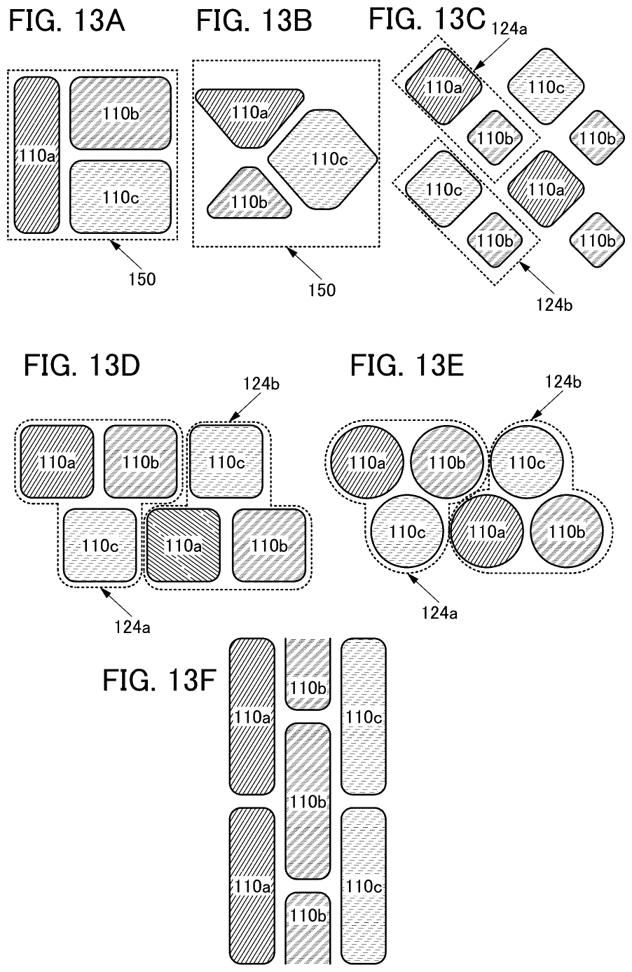

A pixel 150 illustrated in FIG. 13A employs an S-stripe arrangement. The pixel 150 illustrated in FIG. 13A is composed of three subpixels: light-emitting elements 110a, 110b, and 110c. For example, the light-emitting element 110a may be a blue-light-emitting element, the light-emitting element 110b may be a red-light-emitting element, and the light-emitting element 110c may be a green-light-emitting element.

The pixel 150 illustrated in FIG. 13B includes the light-emitting element 110a whose top surface has a rough trapezoidal or rough triangle shape with rounded corners, the light-emitting element 110b whose top surface has a rough trapezoidal or rough triangle shape with rounded 25 corners, and the light-emitting element 110c whose top surface has a rough tetragonal or rough hexagonal shape with rounded corners. In addition, the light-emitting element 110a has a larger light-emitting area than the light-emitting element 110b. In this manner, the shapes and sizes of the light-emitting elements can be independently determined. For example, a light-emitting element with higher reliability can have a smaller size. For example, the light-emitting element 110a may be a green-light-emitting element, the light-emitting element 110b may be a red-light-emitting element, and the light-emitting element 110c may be a blue-light-emitting element.

Pixels 124a and 124b illustrated in FIG. 13C employ PenTile arrangement. FIG. 13C illustrates an example where the pixels 124a each including the light-emitting element 110a and the light-emitting element 110b and the pixels 124b each including the light-emitting element 110b and the light-emitting element 110c are alternately arranged. For example, the light-emitting element 110a may be a red-light-emitting element, the light-emitting element 110b may be a green-light-emitting element, and the light-emitting element 110c may be a blue-light-emitting element.

The pixels 124a and 124b illustrated in FIG. 13D and FIG. 13E employ a delta arrangement. The pixel 124a includes two light-emitting elements (the light-emitting elements 110a and 110b) in an upper row (a first row) and one light-emitting element (the light-emitting element 110c) in a lower row (a second row). The pixel 124b includes one light-emitting element (the light-emitting element 110c) in the upper row (the first row) and two light-emitting elements (the light-emitting elements 110a and 110b) in the lower row (the second row). For example, the light-emitting element 110a may be a red-light-emitting element, the light-emitting element 110b may be a green-light-emitting element, and the light-emitting element 110c may be a blue-light-emitting element.

FIG. 13D illustrates an example in which the top surface of each light-emitting element has a rough tetragonal shape with rounded corners, and FIG. 13E illustrates an example in which the top surface of each light-emitting element is circular.

FIG. 13F illustrates an example in which light-emitting elements of different colors are arranged in a zigzag manner. Specifically, the positions of top sides of two light-emitting elements arranged in a column direction (e.g., the light-emitting element 110a and the light-emitting element 110b or the light-emitting element 110b and the light-emitting element 110c) are not aligned in a top view. For example, the light-emitting element 110a may be a red-light-emitting element, the light-emitting element 110b may be a green-light-emitting element, and the light-emitting element 110c may be a blue-light-emitting element.

In a photolithography method, as a pattern to be processed becomes finer, the influence of light diffraction becomes more difficult to ignore; therefore, fidelity in transferring a photomask pattern by light exposure is degraded, and it becomes difficult to process a resist mask into a desired shape. Thus, a pattern with rounded corners is likely to be formed even with a rectangular photomask pattern. Consequently, the top surface of a light-emitting element has a polygonal shape with rounded corners, an elliptical shape, a circular shape, or the like in some cases.

Furthermore, in a method for manufacturing a display panel according to one embodiment of the present invention, the EL layer is processed into an island shape with the use of a resist mask. A resist film formed over the EL layer needs to be cured at a temperature lower than the heat resistance temperature of the EL layer. Thus, the resist film is insufficiently cured in some cases depending on the heat resistance temperature of the material of the EL layer and the curing temperature of a resist material. An insufficiently cured resist film might have a shape different from a desired shape at the time of processing. As a result, the top surface of the EL layer has a polygonal shape with rounded corners, an elliptical shape, a circular shape, or the like in some cases. For example, when a resist mask with a square top surface is intended to be formed, a resist mask with a circular top surface might be formed, and the top surface of the EL layer might be circular.

Note that to obtain a desired top surface shape of the EL layer, a technique of correcting a mask pattern in advance so that a transferred pattern agrees with a design pattern (an OPC (Optical Proximity Correction) technique) may be used. Specifically, with the OPC technique, a pattern for correction is added to a corner portion or the like of a figure on a mask pattern.

The above is the description of the pixel layout.

At least part of this embodiment can be implemented in combination with the other embodiments and examples described in this specification as appropriate.

### Embodiment 3

In this embodiment, other structure examples of display panels which can be used for an electronic device of one embodiment of the present invention will be described.

Display panels of this embodiment has high resolution, and specifically, the display panel is suitably used for display portions of wearable devices capable of being worn on a head, such as devices for VR like a head-mounted display and glasses-type devices for AR.

### [Display Module]

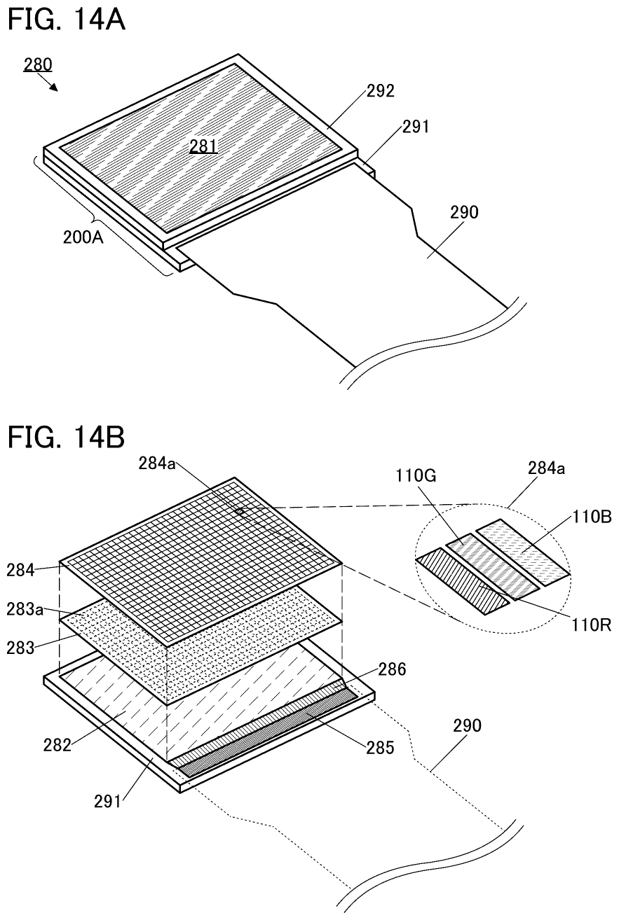

FIG. 14A is a perspective view of a display module 280. The display module 280 includes a display panel 200A and an FPC 290. Note that the display panel included in the display module 280 is not limited to the display panel 200A and may be any of a display panel 200B to a display panel 200F to be described later.

The display module 280 includes a substrate 291 and a substrate 292. The display module 280 includes a display portion 281. The display portion 281 is a region where an image is displayed.

FIG. 14B is a perspective view schematically illustrating the structure on the substrate 291 side. Over the substrate 291, a circuit portion 282, a pixel circuit portion 283 over the circuit portion 282, and the pixel portion 284 over the pixel circuit portion 283 are stacked. In addition, a terminal portion 285 for connection to the FPC 290 is included in a portion over the substrate 291 that does not overlap with the pixel portion 284. The terminal portion 285 and the circuit portion 282 are electrically connected to each other through a wiring portion 286 formed of a plurality of wirings.

The pixel portion 284 includes a plurality of pixels 284a arranged periodically. An enlarged view of one pixel 284a is illustrated on the right side in FIG. 14B. The pixel 284a includes the light-emitting element 110R emitting red light, the light-emitting element 110G emitting green light, and the light-emitting element 110B emitting blue light.

The pixel circuit portion 283 includes a plurality of pixel circuits 283a arranged periodically. One pixel circuit 283a controls light emission from three light-emitting devices included in one pixel 284a. One pixel circuit 283a may include three circuits each of which controls light emission from one light-emitting device. For example, the pixel circuit 283a can include at least one selection transistor, one current control transistor (driving transistor), and a capacitor for one light-emitting device. In this case, a gate signal is input to a gate of the selection transistor, and a source signal is input to a source of the selection transistor. Thus, an active matrix display panel is achieved.

The circuit portion 282 includes a circuit for driving the pixel circuits 283a in the pixel circuit portion 283. For example, the circuit portion 282 preferably includes one or both of agate line driver circuit and a source line driver circuit. The circuit portion 282 may also include at least one of an arithmetic circuit, a memory circuit, a power supply circuit, and the like. A transistor included in the circuit portion 282 may constitute part of the pixel circuit 283a. That is, the pixel circuit 283a may be constituted by a transistor included in the pixel circuit portion 283 and a transistor included in the circuit portion 282.

The FPC 290 functions as a wiring for supplying a video signal, a power supply potential, or the like to the circuit portion 282 from the outside. An IC may be mounted on the FPC 290.

The display module 280 can have a structure in which one or both of the pixel circuit portion 283 and the circuit portion 282 are stacked below the pixel portion 284; hence, the aperture ratio (effective display area ratio) of the display portion 281 can be significantly high. For example, the aperture ratio of the display portion 281 can be higher than or equal to 40% and lower than 100%, preferably higher than or equal to 50% and lower than or equal to 95%, further preferably higher than or equal to 60% and lower than or equal to 95%. Furthermore, the pixels 284a can be arranged extremely densely and thus the display portion 281 can have significantly high resolution. For example, the pixels 284a are preferably arranged in the display portion 281 with a resolution higher than or equal to 2000 ppi, preferably higher than or equal to 3000 ppi, further preferably higher than or equal to 5000 ppi, still further preferably higher than or equal to 6000 ppi, and lower than or equal to 20000 ppi or lower than or equal to 30000 ppi.

Such a display module 280 has extremely high resolution, and thus can be suitably used for a device for VR such as ahead-mounted display or a glasses-type device for AR. For example, even in the case of a structure in which the display portion of the display module 280 is seen through a lens, pixels of the extremely-high-resolution display portion 281 included in the display module 280 are prevented from being recognized when the display portion is enlarged by the lens, so that display providing a high sense of immersion can be performed. Without being limited thereto, the display module 280 can be suitably used for electronic devices including a relatively small display portion. For example, the display module 280 can be suitably used in a display portion of a wearable electronic device, such as a wrist watch.

### [Display Panel 200A]

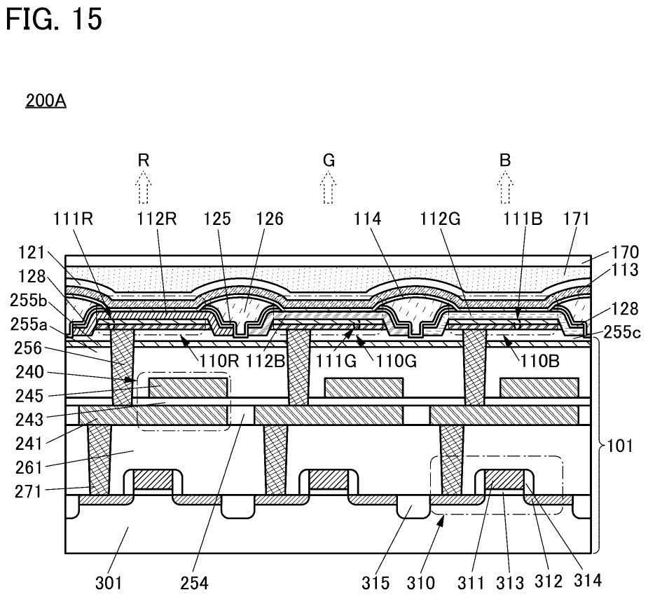

The display panel 200A illustrated in FIG. 15 includes a substrate 301, the light-emitting elements 110R, 110G, and 110B, a capacitor 240, and a transistor 310.

The substrate 301 corresponds to the substrate 291 in FIG. 14A and FIG. 14B.

The transistor 310 includes a channel formation region in the substrate 301. As the substrate 301, a semiconductor substrate such as a single crystal silicon substrate can be used, for example. The transistor 310 includes part of the substrate 301, a conductive layer 311, low-resistance regions 312, an insulating layer 313, and an insulating layer 314. The conductive layer 311 functions as a gate electrode. The insulating layer 313 is positioned between the substrate 301 and the conductive layer 311 and functions as a gate insulating layer. The low-resistance region 312 is a region where the substrate 301 is doped with an impurity, and functions as one of a source and a drain. The insulating layer 314 is provided to cover the side surface of the conductive layer 311.

An element isolation layer 315 is provided between two adjacent transistors 310 to be embedded in the substrate 301.

An insulating layer 261 is provided to cover the transistor 310, and the capacitor 240 is provided over the insulating layer 261.

The capacitor 240 includes a conductive layer 241, a conductive layer 245, and an insulating layer 243 between the conductive layer 241 and the conductive layer 245. The conductive layer 241 functions as one electrode of the capacitor 240, the conductive layer 245 functions as the other electrode of the capacitor 240, and the insulating layer 243 functions as a dielectric of the capacitor 240.

The conductive layer 241 is provided over the insulating layer 261 and is embedded in an insulating layer 254. The conductive layer 241 is electrically connected to one of a source and a drain of the transistor 310 through a plug 271 embedded in the insulating layer 261. The insulating layer 243 is provided to cover the conductive layer 241. The conductive layer 245 is provided in a region overlapping with the conductive layer 241 with the insulating layer 243 therebetween.

An insulating layer 255a is provided to cover the capacitor 240, an insulating layer 255b is provided over the insulating layer 255a, and an insulating layer 255c is provided over the insulating layer 255b.

An inorganic insulating film can be suitably used as each of the insulating layer 255a, the insulating layer 255b, and the insulating layer 255c. For example, it is preferable that a silicon oxide film be used as the insulating layer 255a and the insulating layer 255c and a silicon nitride film be used as the insulating layer 255b. This enables the insulating layer 255b to function as an etching protective film. Although this embodiment describes an example where the insulating layer 255c is partly etched and a depressed portion is formed, the depressed portion is not necessarily provided in the insulating layer 255c.

The light-emitting element 110R, the light-emitting element 110G, and the light-emitting element 1101B are provided over the insulating layer 255c. Embodiment 2 can be referred to for the structures of the light-emitting element 110R, the light-emitting element 110G, and the light-emitting element 110B.

In the display panel 200A, since the light-emitting devices of different colors are separately formed, the difference between the chromaticity at low luminance emission and that at high luminance emission is small. Furthermore, since the organic layers 112R, 112G, and 112B are separated from each other, crosstalk generated between adjacent subpixels can be inhibited while the display panel has high resolution. Accordingly, the display panel can have high resolution and high display quality.

In the region between adjacent light-emitting elements, the insulating layer 125, the resin layer 126, and the layer 128 are provided.

The pixel electrode 111R, the pixel electrode 111G, and the pixel electrode 111B of the light-emitting elements are each electrically connected to one of the source and the drain of the transistor 310 through a plug 256 embedded in the insulating layer 255a, the insulating layer 255b, and the insulating layer 255c, the conductive layer 241 embedded in the insulating layer 254, and the plug 271 embedded in the insulating layer 261. The top surface of the insulating layer 255c and the top surface of the plug 256 are level with or substantially level with each other. Any of a variety of conductive materials can be used for the plugs.

The protective layer 121 is provided over the light-emitting elements 110R, 110G, and 1101B. A substrate 170 is bonded onto the protective layer 121 with an adhesive layer 171.

An insulating layer covering an end portion of the top surface of the pixel electrode 111 is not provided between two adjacent pixel electrodes 111. Thus, the distance between adjacent light-emitting elements can be extremely narrowed. Accordingly, the display panel can have high resolution or high definition.

### [Display Panel 200B]

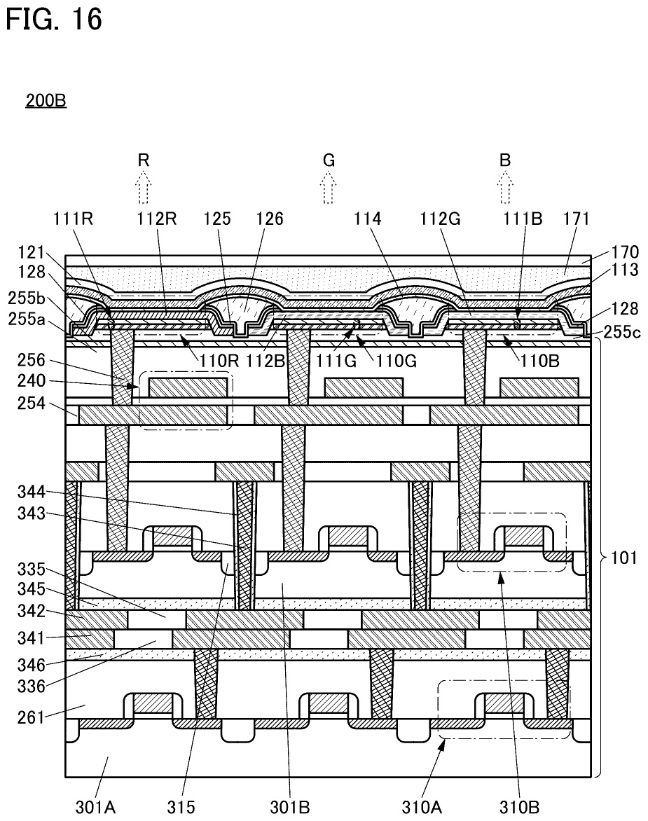

The display panel 200B illustrated in FIG. 16 has a structure in which a transistor 310A and a transistor 310B each having a channel formed in a semiconductor substrate are stacked. Note that in the following description of display panels, the description of portions similar to those of the above-described display panel may be omitted.

In the display panel 200B, a substrate 301B provided with the transistor 310B, the capacitor 240, and the light-emitting devices is attached to a substrate 301A provided with the transistor 310A.

Here, an insulating layer 345 is provided on the bottom surface of the substrate 301B. An insulating layer 346 is provided over the insulating layer 261 over the substrate 301A. The insulating layers 345 and 346 function as protective layers and can inhibit diffusion of impurities into the substrate 301B and the substrate 301A. As the insulating layers 345 and 346, an inorganic insulating film that can be used as the protective layer 121 can be used.

The substrate 301B is provided with a plug 343 that penetrates the substrate 301B and the insulating layer 345. An insulating layer 344 functioning as a protective layer is preferably provided to cover the side surface of the plug 343.

As for the substrate 301B, a conductive layer 342 is provided under the insulating layer 345. The conductive layer 342 is embedded in an insulating layer 335, and bottom surfaces of the conductive layer 342 and the insulating layer 335 are planarized. The conductive layer 342 is electrically connected to the plug 343.

As for the substrate 301A, a conductive layer 341 is provided over the insulating layer 346. The conductive layer 341 is embedded in an insulating layer 336, and top surfaces of the conductive layer 341 and the insulating layer 336 are planarized.

The same conductive material is preferably used for the conductive layer 341 and the conductive layer 342. For example, it is possible to use a metal film containing an element selected from Al, Cr, Cu, Ta, Ti, Mo, and W, or a metal nitride film containing the above elements as a component (a titanium nitride film, a molybdenum nitride film, or a tungsten nitride film). Copper is particularly preferably used for the conductive layer 341 and the conductive layer 342. In that case, it is possible to employ copper-to-copper (Cu-to-Cu) direct bonding (a technique for achieving electrical continuity by connecting copper (Cu) pads).

### [Display Panel 200C]

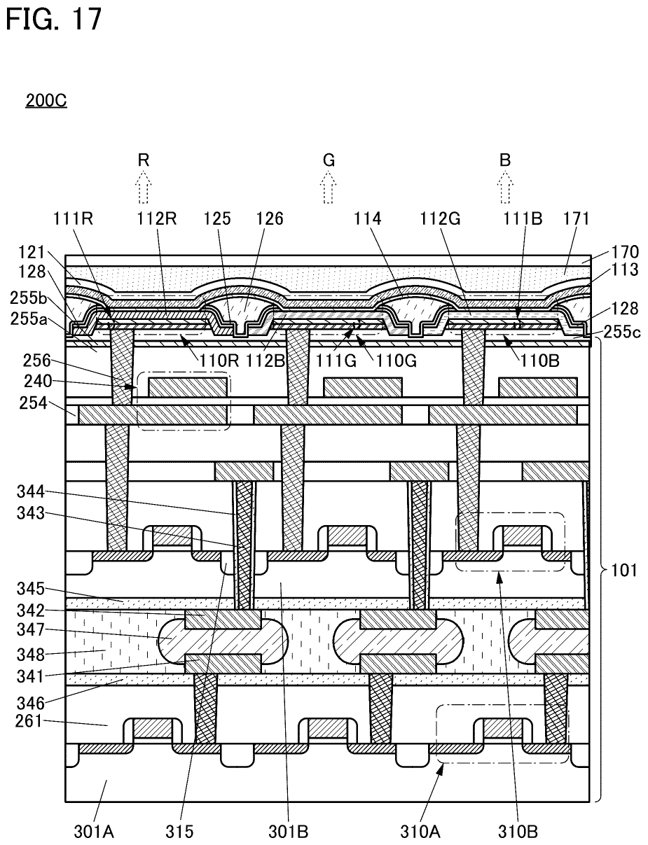

A display panel 200C illustrated in FIG. 17 has a structure in which the conductive layer 341 and the conductive layer 342 are bonded to each other with a bump 347.

As illustrated in FIG. 17, providing the bump 347 between the conductive layer 341 and the conductive layer 342 enables the conductive layer 341 and the conductive layer 342 to be electrically connected to each other. The bump 347 can be formed using a conductive material containing gold (Au), nickel (Ni), indium (In), tin (Sn), or the like, for example. As another example, solder may be used for the bump 347. An adhesive layer 348 may be provided between the insulating layer 345 and the insulating layer 346. In the case where the bump 347 is provided, the insulating layer 335 and the insulating layer 336 may be omitted.

### [Display Panel 200D]

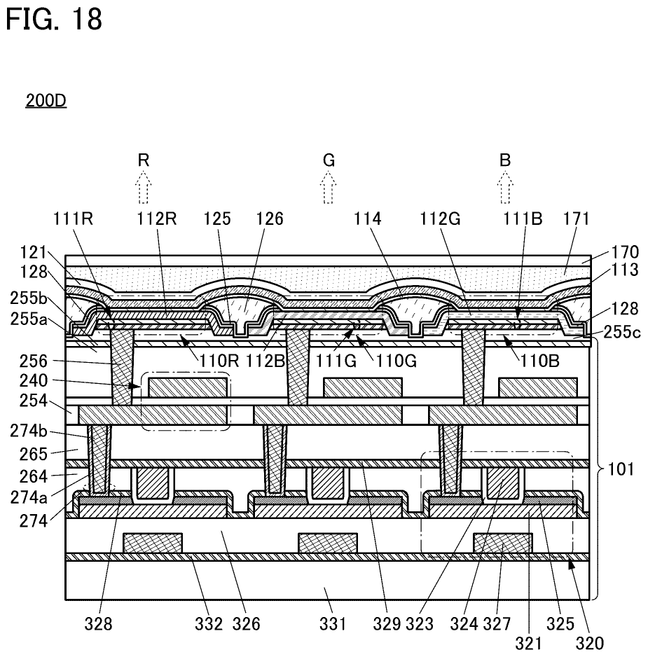

A display panel 200D illustrated in FIG. 18 differs from the display panel 200A mainly in a structure of a transistor.

A transistor 320 is a transistor that contains a metal oxide (also referred to as an oxide semiconductor) in a semiconductor layer where a channel is formed (an OS transistor).

The transistor 320 includes a semiconductor layer 321, an insulating layer 323, a conductive layer 324, a pair of conductive layers 325, an insulating layer 326, and a conductive layer 327.

A substrate 331 corresponds to the substrate 291 in FIG. 14A and FIG. 14B.

An insulating layer 332 is provided over the substrate 331. The insulating layer 332 functions as a barrier layer that prevents diffusion of impurities such as water or hydrogen from the substrate 331 into the transistor 320 and release of oxygen from the semiconductor layer 321 to the insulating layer 332 side. As the insulating layer 332, for example, a film in which hydrogen or oxygen is less likely to diffuse than in a silicon oxide film, such as an aluminum oxide film, a hafnium oxide film, or a silicon nitride film can be used.

The conductive layer 327 is provided over the insulating layer 332, and the insulating layer 326 is provided to cover the conductive layer 327. The conductive layer 327 functions as a first gate electrode of the transistor 320, and part of the insulating layer 326 functions as a first gate insulating layer. An oxide insulating film such as a silicon oxide film is preferably used for at least the part of the insulating layer 326 that is in contact with the semiconductor layer 321. The top surface of the insulating layer 326 is preferably planarized.

The semiconductor layer 321 is provided over the insulating layer 326. A metal oxide film having semiconductor characteristics (also referred to as an oxide semiconductor film) is preferably used as the semiconductor layer 321. The pair of conductive layers 325 is provided on and in contact with the semiconductor layer 321, and functions as a source electrode and a drain electrode.

An insulating layer 328 is provided to cover the top surface and the side surface of the pair of conductive layers 325, the side surface of the semiconductor layer 321, and the like, and an insulating layer 264 is provided over the insulating layer 328. The insulating layer 328 functions as a barrier layer that prevents diffusion of impurities such as water or hydrogen from the insulating layer 264 and the like into the semiconductor layer 321 and release of oxygen from the semiconductor layer 321. As the insulating layer 328, an insulating film similar to the insulating layer 332 can be used.

An opening reaching the semiconductor layer 321 is provided in the insulating layer 328 and the insulating layer 264. The insulating layer 323 that is in contact with the top surface of the semiconductor layer 321 and the conductive layer 324 are embedded in the opening portion. The conductive layer 324 functions as a second gate electrode, and the insulating layer 323 functions as a second gate insulating layer.

The top surface of the conductive layer 324, the top surface of the insulating layer 323, and the top surface of the insulating layer 264 are planarized so that they are level with or substantially level with each other, and an insulating layer 329 and an insulating layer 265 are provided to cover these layers.

The insulating layer 264 and the insulating layer 265 each function as an interlayer insulating layer. The insulating layer 329 functions as a barrier layer that prevents diffusion of impurities such as water or hydrogen from the insulating layer 265 or the like to the transistor 320. As the insulating layer 329, an insulating film similar to the insulating layer 328 and the insulating layer 332 can be used.

A plug 274 that is electrically connected to one of the pair of conductive layers 325 is provided to be embedded in the insulating layer 265, the insulating layer 329, and the insulating layer 264. Here, the plug 274 preferably includes a conductive layer 274a that covers the side surface of an opening formed in the insulating layer 265, the insulating layer 329, the insulating layer 264, and the insulating layer 328 and part of the top surface of the conductive layer 325, and a conductive layer 274b in contact with the top surface of the conductive layer 274a. For the conductive layer 274a, a conductive material in which hydrogen and oxygen are less likely to diffuse is preferably used.

There is no particular limitation on the structure of the transistors included in the display panel of this embodiment. For example, a planar transistor, a staggered transistor, or an inverted staggered transistor can be used. A top-gate transistor or a bottom-gate transistor can be used. Alternatively, gates may be provided above and below a semiconductor layer where a channel is formed.

The structure in which the semiconductor layer where a channel is formed is provided between two gates is used for the transistor 320. The two gates may be connected to each other and supplied with the same signal to drive the transistor. Alternatively, the threshold voltage of the transistor may be controlled by supplying a potential for controlling the threshold voltage to one of the two gates and supplying a potential for driving to the other of the two gates.

There is no particular limitation on the crystallinity of a semiconductor material used in the semiconductor layer of the transistor, and an amorphous semiconductor, a single crystal semiconductor, or a semiconductor having crystallinity other than single crystal (a microcrystalline semiconductor, a polycrystalline semiconductor, or a semiconductor partly including crystal regions) can be used. A single crystal semiconductor or a semiconductor having crystallinity is preferably used, in which case deterioration of the transistor characteristics can be inhibited.

The bandgap of a metal oxide used for the semiconductor layer of the transistor is preferably higher than or equal to 2 eV, further preferably higher than or equal to 2.5 eV. The use of such a metal oxide having a wide band gap can reduce the off-state current of the OS transistor.

A metal oxide preferably contains at least indium or zinc, and further preferably contains indium and zinc. The metal oxide preferably contains indium, M (M is one or more of gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example.

Alternatively, the semiconductor layer of the transistor may contain silicon. Examples of silicon include amorphous silicon and crystalline silicon (e.g., low-temperature polysilicon or single crystal silicon).

Examples of the metal oxide that can be used for the semiconductor layer include indium oxide, gallium oxide, and zinc oxide. The metal oxide preferably contain two or three kinds selected from indium, the element M, and zinc. The element M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium. Specifically, the element M is preferably one or more kinds selected from aluminum, gallium, yttrium, and tin.

It is particularly preferable that an oxide containing indium, gallium, and zinc (also referred to as IGZO) be used as the metal oxide used for the semiconductor layer. Alternatively, it is preferable to use an oxide containing indium, tin, and zinc (also referred to as ITZO (registered trademark)). Alternatively, it is preferable to use an oxide containing indium, gallium, tin, and zinc. Alternatively, it is preferable to use an oxide containing indium, aluminum, and zinc (also referred to as IAZO). Alternatively, it is preferable to use an oxide containing indium, aluminum, gallium, and zinc (also referred to as IAGZO).

In the case where the metal oxide used for the semiconductor layer is an In-M-Zn oxide, the atomic proportion of In is preferably higher than or equal to the atomic proportion of M in the In-M-Zn oxide. Examples of the atomic ratio of the metal elements in such an In-M-Zn oxide are In:M:Zn=1:1:1 and a composition in the vicinity thereof, In:M:Zn=1:1:1.2 and a composition in the vicinity thereof, In:M:Zn=1:3:2 and a composition in the vicinity thereof, In:M:Zn=1:3:4 and a composition in the vicinity thereof, In:M:Zn=2:1:3 and a composition in the vicinity thereof, In:M:Zn=3:1:2 and a composition in the vicinity thereof, In:M:Zn=4:2:3 and a composition in the vicinity thereof, In:M:Zn=4:2:4.1 and a composition in the vicinity thereof, In:M:Zn=5:1:3 35 and a composition in the vicinity thereof, In:M:Zn=5:1:6 and a composition in the vicinity thereof, In:M:Zn=5:1:7 and a composition in the vicinity thereof, In:M:Zn=5:1:8 and a composition in the vicinity thereof, In:M:Zn=6:1:6 and a composition in the vicinity thereof, and In:M:Zn=5:2:5 and a composition in the vicinity thereof. Note that the vicinity of the atomic ratio includes ±30% of an intended atomic ratio.

For example, when the atomic ratio is described as In:Ga:Zn=4:2:3 or a composition in the vicinity thereof, the case is included where the atomic proportion of Ga is greater than or equal to 1 and less than or equal to 3 and the atomic proportion of Zn is greater than or equal to 2 and less than or equal to 4 with the atomic proportion of In being 4. In addition, when the atomic ratio is described as In:Ga:Zn=5:1:6 or a composition in the vicinity thereof, the case is included where the atomic proportion of Ga is greater than 0.1 and less than or equal to 2 and the atomic proportion of Zn is greater than or equal to 5 and less than or equal to 7 with the atomic proportion of In being 5. Furthermore, when the atomic ratio is described as In:Ga:Zn=1:1:1 or a composition in the vicinity thereof, the case is included where the atomic proportion of Ga is greater than 0.1 and less than or equal to 2 and the atomic proportion of Zn is greater than 0.1 and less than or equal to 2 with the atomic proportion of In being 1.

The semiconductor layer may include two or more metal oxide layers having different compositions. For example, a stacked-layer structure of a first metal oxide layer having In:M:Zn==1:3:4 [atomic ratio] or a composition in the vicinity thereof and a second metal oxide layer having In:M:Zn=1:1:1 [atomic ratio] or a composition in the vicinity thereof and being formed over the first metal oxide layer can be suitably employed. In particular, gallium or aluminum is preferably used as the element M.

Alternatively, a stacked-layer structure or the like of one selected from indium oxide, indium gallium oxide, and IGZO, and one selected from IAZO, IAGZO, and ITZO (registered trademark) may be used, for example.

As examples of the oxide semiconductor having crystallinity, a CAAC (c-axis-aligned crystalline)-OS, an nc (nanocrystalline)-OS, and the like are given.

An OS transistor has much higher field-effect mobility than a transistor containing amorphous silicon. In addition, the OS transistor has an extremely low leakage current between a source and a drain in an off state (the leakage current is also referred to as an off-state current), and charge accumulated in a capacitor that is connected in series to the transistor can be retained for a long period. Furthermore, the power consumption of the display panel can be reduced with the OS transistor.

To increase the emission luminance of the light-emitting device included in the pixel circuit, the amount of a current flowing through the light-emitting device needs to be increased. To increase the current amount, the source-drain voltage of a driving transistor included in the pixel circuit needs to be increased. An OS transistor has a higher breakdown voltage between a source and a drain than a Si transistor; hence, a high voltage can be applied between the source and the drain of the OS transistor. Thus, with use of an OS transistor as the driving transistor included in the pixel circuit, the amount of a current flowing through the light-emitting device can be increased, resulting in an increase in emission luminance of the light-emitting device.

Assuming that the transistor operates in a saturation region, a change in the amount of a current between the source and the drain, with respect to a fluctuation in the gate-source voltage, in the OS transistor is smaller than that in the Si transistor. Accordingly, when an OS transistor is used as the driving transistor in the pixel circuit, a current flowing between the source and the drain can be set minutely in accordance with a change in gate-source voltage; hence, the amount of a current flowing through the light-emitting device can be controlled. Consequently, the number of gray levels expressed by the pixel circuit can be increased.

Regarding saturation characteristics of a current flowing when a transistor operates in a saturation region, a current (saturation current) can flow more stably in an OS transistor than in a Si transistor even when the source-drain voltage gradually increases. Thus, with the use of an OS transistor as the driving transistor, a current can be made to flow stably through the light-emitting device, for example, even when a variation in current-voltage characteristics of the EL device occurs. In other words, when the OS transistor operates in the saturation region, the source-drain current hardly changes with an increase in the source-drain voltage; hence, the emission luminance of the light-emitting device can be stable.

As described above, with the use of an OS transistor as the driving transistor included in the pixel circuit, it is possible to achieve “reduction in power consumption”, “increase in emission luminance”, “increase in gray level”, “inhibition of variation in light-emitting devices”, and the like.

### [Display Panel 200F]

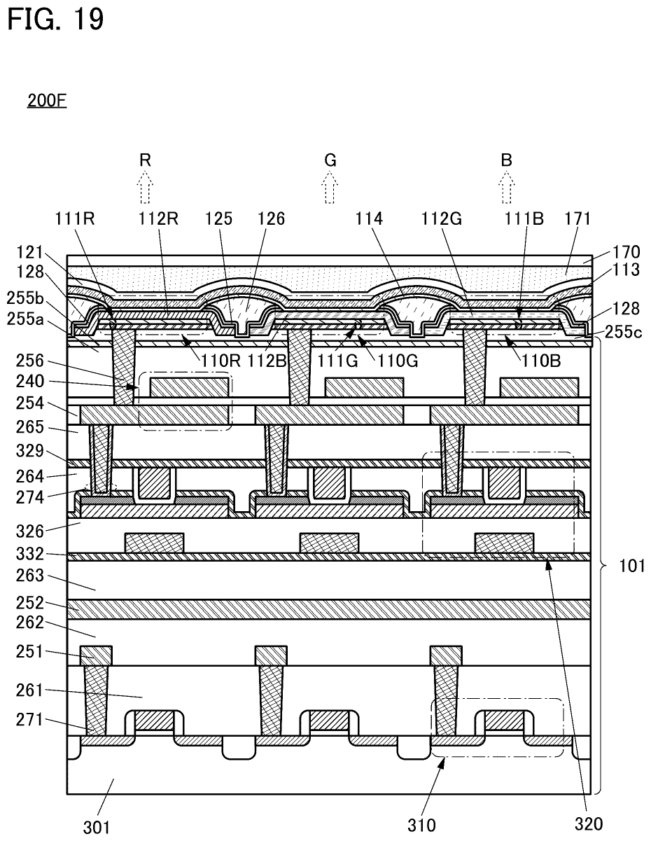

The display panel 200F illustrated in FIG. 19 has a structure in which the transistor 310 having a channel formed in the substrate 301 and the transistor 320 containing a metal oxide in a semiconductor layer where a channel is formed are stacked.

The insulating layer 261 is provided to cover the transistor 310, and a conductive layer 251 is provided over the insulating layer 261. An insulating layer 262 is provided to cover the conductive layer 251, and a conductive layer 252 is provided over the insulating layer 262. The conductive layer 251 and the conductive layer 252 each function as a wiring. An insulating layer 263 and the insulating layer 332 are provided to cover the conductive layer 252, and the transistor 320 is provided over the insulating layer 332. The insulating layer 265 is provided to cover the transistor 320, and the capacitor 240 is provided over the insulating layer 265. The capacitor 240 and the transistor 320 are electrically connected to each other through the plug 274.

The transistor 320 can be used as a transistor included in the pixel circuit. The transistor 310 can be used as a transistor included in the pixel circuit or a transistor included in a driver circuit for driving the pixel circuit (a gate line driver circuit or a source line driver circuit). The transistor 310 and the transistor 320 can also be used as transistors included in a variety of circuits such as an arithmetic circuit and a memory circuit.

With such a structure, not only the pixel circuit but also the driver circuit and the like can be formed directly under the light-emitting devices; thus, the display panel can be downsized as compared with the case where a driver circuit is provided around a display region.

### [Display Panel 200G]

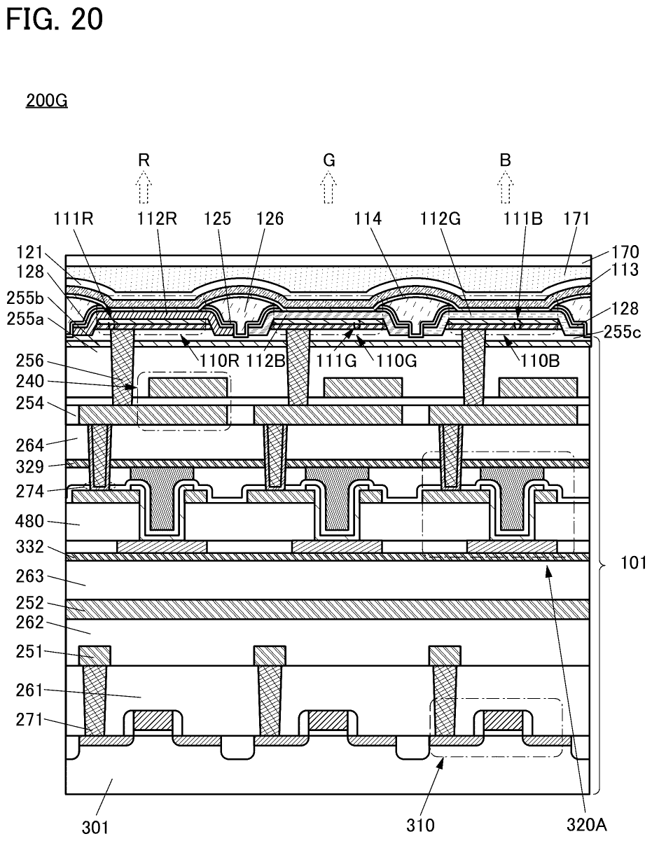

A display panel 200G illustrated in FIG. 20 has a structure in which the transistor 320 in the display panel 200F illustrated in FIG. 19 is replaced with a transistor 320A (vertical transistor). Note that the structure in which the transistor 320 is replaced with the transistor 320A can also be employed for the display panel 200D illustrated in FIG. 18.

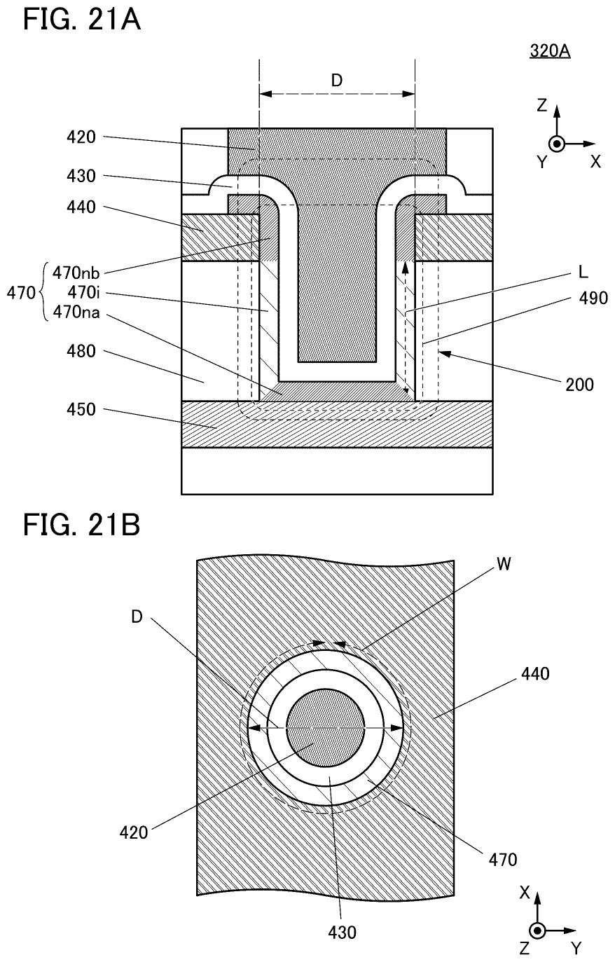

FIG. 21A is a cross-sectional view of the transistor 320A along the X-Z plane. FIG. 21B is a cross-sectional view along the X-Y plane including a wiring 440.

The transistor 320A includes an oxide semiconductor 470, an insulator 430, and a conductor 420. The oxide semiconductor 470 functions as a semiconductor layer, the insulator 430 functions as a gate insulator, and the conductor 420 functions as a gate electrode. A wiring 450 includes a region that functions as one of a source electrode and a drain electrode of the transistor 320A. The wiring 440 includes a region that functions as the other of the source electrode and the drain electrode of the transistor 320A.

An opening portion 490 penetrating through the wiring 440 and an insulator 480 and reaching the wiring 450 is provided. The opening portion 490 has a pillar shape with a substantially circular top surface. This structure enables miniaturization or high integration of the memory cell. Note that the side surface of the opening portion 490 is preferably perpendicular to the top surface of the wiring 450.

At least part of the oxide semiconductor 470 is provided in the opening portion 490. Note that the oxide semiconductor 470 includes a region in contact with the top surface of the wiring 450, a region in contact with the side surface of the wiring 440, and a region in contact with the side surface of the insulator 480 in the opening portion 490.

The insulator 430 is provided so as to at least partly cover the opening portion 490. The conductor 420 is provided so that at least part of the conductor 420 is positioned in the opening portion 490. The conductor 420 is preferably provided so as to be embedded in the opening portion 490, and the shape of the conductor 420 in the top view is preferably substantially circular for a higher integration degree.

As illustrated in FIG. 21A, the oxide semiconductor 470 includes a region 470i, and a region 470na and a region 470nb provided with the region 470i positioned therebetween.

The region 470na is a region in contact with the wiring 450 in the oxide semiconductor 470. At least part of the region 470na functions as one of the source region and the drain region of the transistor 320A. The region 470nb is a region in contact with the wiring 440 in the oxide semiconductor 470. At least part of the region 470nb functions as the other of the source region and the drain region of the transistor 320A. As illustrated in FIG. 21B, the wiring 440 is in contact with all the perimeter of the oxide semiconductor 470. Thus, the other of the source region and the drain region of the transistor 320A can be formed along all the perimeter of a region formed in the same layer as the wiring 440 in the oxide semiconductor 470.

The region 470i is a region positioned between the region 470na and the region 470nb in the oxide semiconductor 470. At least part of the region 470i functions as the channel formation region of the transistor 320A. That is, the channel formation region of the transistor 320A is formed in part of the oxide semiconductor 470 that is positioned in a region between the wiring 450 and the wiring 440. It can be said that the channel formation region of the transistor 320A is positioned in a region in contact with the insulator 480 or a region in the vicinity thereof in the oxide semiconductor 470.

The channel length of the transistor 320A is a distance between the source region and the drain region. That is, the channel length of the transistor 320A is determined by the thickness of the insulator 480 over the wiring 450. In FIG. 21A, a channel length L of the transistor 320A is indicated by a dashed double-headed arrow. The channel length L is a distance between an end portion of a region where the oxide semiconductor 470 and the wiring 450 are in contact with each other and an end portion of a region where the oxide semiconductor 470 and the wiring 440 are in contact with each other in a cross-sectional view. That is, the channel length L corresponds to the length of the side surface of the insulator 480 on the opening portion 490 side in the cross-sectional view.

The channel length of a conventional transistor is determined by the light exposure limit of photolithography. In contrast, in one embodiment of the present invention, the channel length can be determined by the thickness of the insulator 480. Thus, the transistor 320A can have an extremely small channel length less than or equal to the light exposure limit of photolithography (e.g., less than or equal to 60 nm, less than or equal to 50 nm, less than or equal to 40 nm, less than or equal to 30 nm, less than or equal to 20 nm, or less than or equal to 10 nm, and greater than or equal to 1 nm, or greater than or equal to 5 nm). Accordingly, the transistor 320A can have a high on-state current.

In addition, as described above, the channel formation region, the source region, and the drain region can be formed in the opening portion 490. Thus, the area occupied by the transistor 320A can be reduced as compared with a conventional transistor in which the channel formation region, the source region, and the drain region are provided separately on the X-Y plane. Accordingly, the pixel density can be increased.

The transistor including the channel formation region along the side surface of the insulator 480 in the opening portion 490 in the above-described manner is referred to as a vertical transistor.

Furthermore, in the X-Y plane including the channel formation region of the oxide semiconductor 470, as illustrated in FIG. 21B, the oxide semiconductor 470, the insulator 430, and the conductor 420 are provided concentrically. Therefore, the side surface of the conductor 420 provided at the center faces a side surface of the oxide semiconductor 470 with the insulator 430 therebetween. That is, in the top view, all the perimeter of the oxide semiconductor 470 serves as the channel formation region. In this case, for example, the channel width of the transistor 320A is determined by the length of the perimeter of the oxide semiconductor 470. In other words, the channel width of the transistor 320A is determined by the maximum width of the opening portion 490 (the maximum diameter in the case where the opening portion 490 is circular in the top view). In FIG. 21A and FIG. 21B, a maximum width D of the opening portion 490 is indicated by a dashed double-dotted double-headed arrow. In FIG. 21B, a channel width W of the transistor 320A is indicated by a dashed-dotted double-headed arrow. By increasing the maximum width D of the opening portion 490, the channel width per unit area can be increased and the on-state current can be increased.

In the case where the opening portion 490 is formed by a photolithography method, the maximum width D of the opening portion 490 is determined by the light exposure limit of photolithography. In addition, the maximum width D of the opening portion 490 is determined by the film thicknesses of the oxide semiconductor 470, the insulator 430, and the conductor 420 provided in the opening portion 490. The maximum width D of the opening portion 490 is preferably, for example, greater than or equal to 5 nm, greater than or equal to 10 nm, or greater than or equal to 20 nm and less than or equal to 100 nm, less than or equal to 60 nm, less than or equal to 50 nm, less than or equal to 40 nm, or less than or equal to 30 nm. In the case where the opening portion 490 is circular in the top view, the maximum width D of the opening portion 490 corresponds to the diameter of the opening portion 490, and the channel width W can be calculated to be “D×π”.

In the memory device of one embodiment of the present invention, the channel length L of the transistor 320A is preferably shorter than at least the channel width W of the transistor 320A. The channel length L of the transistor 320A in one embodiment of the present invention is greater than or equal to 0.1 times and less than or equal to 0.99 times, preferably greater than or equal to 0.5 times and less than or equal to 0.8 times the channel width W of the transistor 320A. This structure enables a transistor with favorable electrical characteristics and high reliability.

In the case where the opening portion 490 is formed to be substantially circular in the top view, the oxide semiconductor 470, the insulator 430, and the conductor 420 are formed concentrically. This makes the distance between the conductor 420 and the oxide semiconductor 470 substantially uniform, so that a gate electric field can be substantially uniformly applied to the oxide semiconductor 470.

It is preferable that the channel formation region of the transistor including an oxide semiconductor in the semiconductor layer contain less oxygen vacancies or have a lower concentration of impurities such as hydrogen, nitrogen, or a metal element than the source region and the drain region. In some cases, hydrogen in the vicinity of an oxygen vacancy forms a defect that is an oxygen vacancy into which hydrogen enters (hereinafter sometimes referred to as V_{O}H), which generates an electron serving as a carrier. Thus, it is preferable that the amount of V_{O}H be also reduced in the channel formation region. Thus, the channel formation region of the transistor is a high-resistance region having a low carrier concentration. Accordingly, the channel formation region of the transistor can be regarded as an i-type (intrinsic) or substantially i-type region.

The source region and the drain region of the transistor including an oxide semiconductor in the semiconductor layer are regions which have lower resistances than the channel formation region by having increased carrier concentrations because of containing more oxygen vacancies or more V_{O}H or having higher concentrations of impurities such as hydrogen, nitrogen, or a metal element. In other words, the source region and the drain region of the transistor are n-type regions having higher carrier concentrations and lower resistances than the channel formation region.

Although the opening portion 490 is provided so that the side surface of the opening portion 490 is perpendicular to the top surface of the wiring 450 in FIG. 21A and the like, the present invention is not limited thereto. For example, the side surface of the opening portion 490 may have a tapered shape.

At least part of this embodiment can be implemented in combination with the other embodiments and examples described in this specification as appropriate.

### EXAMPLE

In this example, results of prototyping a glasses-type device for VR with the use of the optical device 40 illustrated in FIG. 8 and a 1.5-inch diagonal OLED microdisplay will be described.

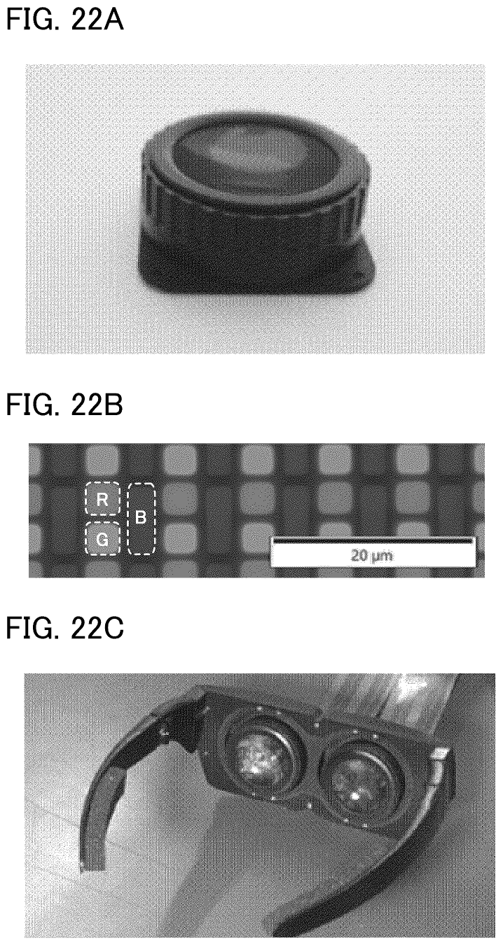

FIG. 22A is a photograph of the prototyped optical device. As each of the lens 46 and the lens 47 illustrated in FIG. 8, a lens formed of an optical polyester resin with a refractive index of approximately 1.65 was used. As the component 41 and the component 42 of the optical unit 45, optical glass BK7, was used.

The distance between a display and an eye was designed to be 30 mm, and an eye relief was designed to be approximately 12 mm. This makes an electronic device using this optical device difficult for a user to wear on glasses; thus, the electronic device has a function of adjusting a diopter scale from −1D to −7D by moving the lens such that people with myopia can bring images into focus.

FIG. 22B shows a micrograph of pixels (3207 ppi), which emit light, of a display panel fabricated by a photolithography method. R, G, and B represent a subpixel that emits red light, a subpixel that emits green light, and a subpixel that emits blue light, respectively. The subpixels did not exhibit uneven emissions, indicating that the patterning was successful.

Table 2 shows the specifications of the 1.50-inch OLED microdisplay. By fabricating the pixels using a photolithography method, high current efficiency was obtained, and a maximum luminance of 5000 cd/m² or higher was achieved. The aperture ratio was extremely high at 62.3%.

TABLE 2

| | Specifications |
|---|---|
| Size | 1.50-inch diagonal |
| | 30.41 mm (H) × 22.81 mm (V) |
| Aspect ratio | 4:3 |
| Pixel density | 3207 ppi |
| Subpixel size | 7.92 μm (H), 7.92 μm (V) |
| Structure | OLED/OS/Si |
| Pixel arrangement | RGB S stripe |
| Aperture ratio | 62.30% |
| Coloring method | Separate coloring by lithography |
| Light extracton method | Top emission |
| Maximum luminance | Higher than or equal to 5,000 cd/m² |
| Color reproducibility | DCI-P3 coverage |
| | higher than or equal to 99% |
| Source driver | Incorporated |
| Scan driver | Incorporated |

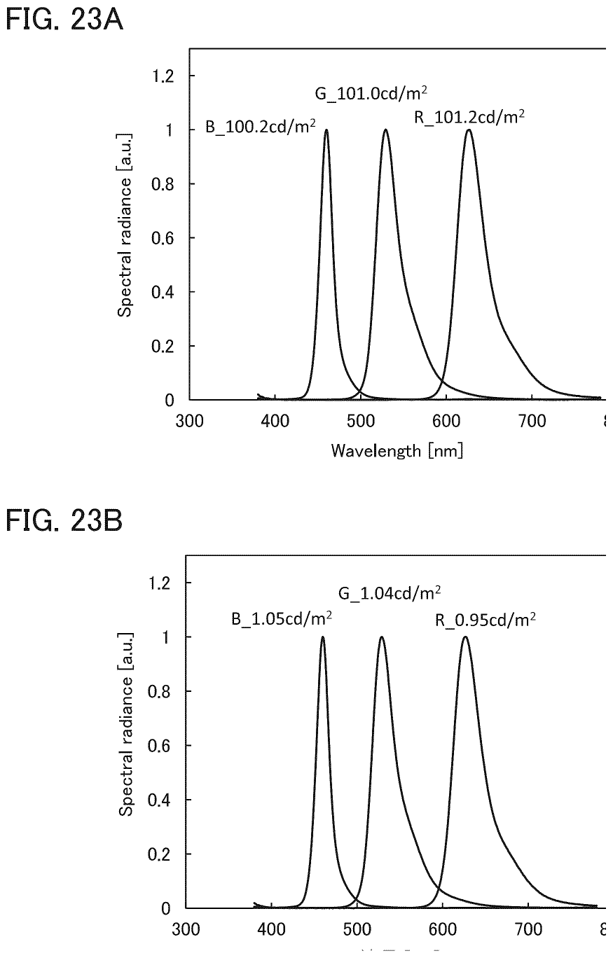

FIG. 23A shows emission spectra at high luminance (approximately 100 cd/m²). FIG. 23B shows emission spectra at low luminance (approximately 1 cd/m²). It is found that the use of a photolithography method can inhibit current leakage between EL elements, which means that color mixing does not occur and a wide color range can be obtained regardless of the luminance. In terms of the color range, DCI-P3 coverage was higher than or equal to 99%.

FIG. 22C shows a photograph of a glasses-type VR device including the optical device and the prototyped 1.50-inch diagonal OLED microdisplay. Since a high-resolution panel was used, a defect such as the screen-door effect did not occur.

In order to verify the performance of the prototyped optical device, a field of view (FOV) was measured. As a measurement method, a method in which, the optical device was set over a light source with a uniform in-plane luminance and a light-emitting area as large as the size of the display (a diagonal of 1.50 inches), and the luminance was measured while the angle of a photodetector was varied, was used. The field of view was set to the angle at which the luminance become half of the front luminance. It was confirmed from the results of the field of view measurement that the field of view was 97° in the lateral direction and 93° in the vertical direction and a sufficiently wide field of view was achieved despite a relatively small display size.

Furthermore, stray light was inhibited to such a degree that it cannot be visually recognized even in a video with a high contrast. The prototyped optical device was set over the display, and the luminance at the time of white display on the entire screen and the luminance of a black circle at the time of displaying the black circle with a diameter of 100 pixels on the white background were measured from the front direction. A two-dimensional spectroradiometer SR-5100HM manufactured by TOPCON TECHNOHOUSE CORPORATION was used as a measurement instrument, and a high-resolution lens LM5JC1M manufactured by KOWA OPTRONICS CO., LTD. was attached to the measurement instrument so that measurement was performed under conditions similar to those of actual viewing with human eyes.

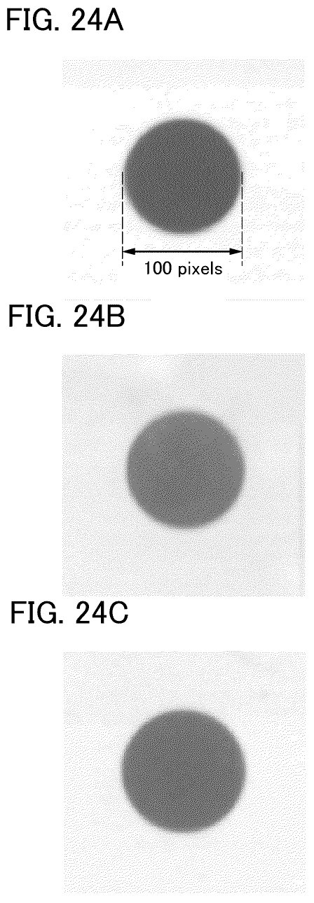

When the black circle is displayed, stray light due to white background display occurs, and thus the luminance increases in accordance with the amount of stray light. A contrast ratio obtained from the luminances of the white display on the entire screen and the display of the black circle was used as an index of the amount of stray light. The evaluation results are shown in FIG. 24 and Table 3. FIG. 24A is a photograph of display using the prototyped optical device, FIG. 24B is a display photograph of the case where the optical device of Product A was used, and FIG. 24C is a display photograph of the case where the optical device of Product B was used.

TABLE 3

| | Contrast ratio |
|---|---|
| Prototyped optical device | 9.1 |
| Product A | 2.4 |
| Product B | 3.8 |

As shown in Table 3, the prototyped optical device had a contrast ratio approximately three times higher than those of the products, which indicates that stray light was reduced.

### REFERENCE NUMERALS

10: eye, 30: display panel, 32: linear polarizing plate, 33: retardation plate, 40: optical device, 41: component, 42: component, 43: optical adhesive, 44: lens, 45: optical unit, 46: lens, 47: lens, 52: layer, 53: retardation plate, 54: reflective polarizing plate, 70: pixel, 71: subpixel, 74: pixel array, 75: circuit, 76: circuit, 77: layer, 78: layer, 79: layer, 90: housing, 91: band, 92: display unit, 100a: display panel, 100b: display panel, 100: display panel, 101: substrate, 110a: light-emitting element, 110B: light-emitting element, 110b: light-emitting element, 110c: light-emitting element, 110G: light-emitting element, 110R: light-emitting element, 110W: light-emitting element, 110: light-emitting element, 111B: pixel electrode, 111C: connection electrode, 111G: pixel electrode, 111R: pixel electrode, 111: pixel electrode, 112B: organic layer, 112G: organic layer, 112R: organic layer, 112W: organic layer, 112: organic layer, 113: common electrode, 114: common layer, 115B: conductive layer, 115G: conductive layer, 115R: conductive layer, 116B: coloring layer, 116G: coloring layer, 116R: coloring layer, 121: protective layer, 122: insulating layer, 123: insulating layer, 124a: pixel, 124b: pixel, 125: insulating layer, 126: resin layer, 128: layer, 140: connection portion, 150: pixel, 170: substrate, 171: adhesive layer, 200A: display panel, 200B: display panel, 200C: display panel, 200D: display panel, 200F: display panel, 200G: display panel, 240: capacitor, 241: conductive layer, 243: insulating layer, 245: conductive layer, 251: conductive layer, 252: conductive layer, 254: insulating layer, 255a: insulating layer, 255b: insulating layer, 255c: insulating layer, 256: plug, 261: insulating layer, 262: insulating layer, 263: insulating layer, 264: insulating layer, 265: insulating layer, 271: plug, 274a: conductive layer, 274b: conductive layer, 274: plug, 280: display module, 281: display portion, 282: circuit portion, 283a: pixel circuit, 283: pixel circuit portion, 284a: pixel, 284: pixel portion, 285: terminal portion, 286: wiring portion, 290: FPC, 291: substrate, 292: substrate, 301A: substrate, 301B: substrate, 301: substrate, 310A: transistor, 310B: transistor, 310: transistor, 311: conductive layer, 312: low-resistance region, 313: insulating layer, 314: insulating layer, 315: element isolation layer, 320A: transistor, 320: transistor, 321: semiconductor layer, 323: insulating layer, 324: conductive layer, 325: conductive layer, 326: insulating layer, 327: conductive layer, 328: insulating layer, 329: insulating layer, 331: substrate, 332: insulating layer, 335: insulating layer, 336: insulating layer, 341: conductive layer, 342: conductive layer, 343: plug, 344: insulating layer, 345: insulating layer, 346: insulating layer, 347: bump, 348: adhesive layer, 420: conductor, 430: insulator, 440: wiring, 450: wiring, 470i: region, 470na: region, 470nb: region, 470: oxide semiconductor, 480: insulator, 490: opening portion

1. An optical device comprising:
a first circularly polarizing plate, a half mirror, and a second circularly polarizing plate,
wherein the half mirror is provided between the first circularly polarizing plate and the second circularly polarizing plate,
wherein the half mirror has a curved surface that is concave on a side of the second circularly polarizing plate,
wherein the half mirror is interposed between a first component and a second component, and
wherein a difference between a refractive index of the first component and a refractive index of the second component is less than or equal to 0.3.

2. The optical device according to claim 1,
wherein one or both of the first component and the second component serve as a lens.

3. The optical device according to claim 1,
wherein an optical adhesive is provided between the first component and the half mirror or between the second component and the half mirror, and
wherein a difference between a maximum value and a minimum value of the refractive index of the first component, the refractive index of the second component, and a refractive index of the optical adhesive is less than or equal to 0.3.

4. The optical device according to claim 1,
wherein the first circularly polarizing plate is bonded to the first component with an optical adhesive, and the second circularly polarizing plate is bonded to the second component with an optical adhesive.

5. The optical device according to claim 4,
wherein each of an adhesive surface between the first circularly polarizing plate and the first component and an adhesive surface between the second circularly polarizing plate and the second component is flat.

6. The optical device according to claim 1,
wherein the first circularly polarizing plate comprises a linear polarizing plate and a first retardation plate, and the second circularly polarizing plate comprises a second retardation plate and a reflective polarizing plate.

7. The optical device according to claim 1,
wherein the first circularly polarizing plate is configured to generate first circularly polarized light, and
wherein the second circularly polarizing plate is configured to reflect the first circularly polarized light and to transmit second circularly polarized light whose rotating direction is opposite to a rotating direction of the first circularly polarized light.

8. The optical device according to claim 1,
wherein a convex lens is provided.

9. An electronic device comprising:
the optical device according to claim 8 and a display panel,
wherein the first circularly polarizing plate is provided between the display panel and the half mirror, and
wherein the second circularly polarizing plate is provided between the half mirror and the convex lens.

10. An electronic device comprising:
the optical device according to claim 8 and a display panel,
wherein the convex lens is provided between the display panel and the first circularly polarizing plate.

11. An electronic device comprising:
the optical device according to claim 8 and a display panel,
wherein the display panel comprises an organic EL element.
